(19) United States
(12) Patent Application Publication
(10) Pub. No.: US 2009/0192849 A1
(43) Pub. Date: Jul. 30, 2009

(54) SYSTEM AND METHOD FOR SOFTWARE DEVELOPMENT

(76) Inventors: John M. Hughes, Hebron, CT (US); David Messinger, West Hartford, CT (US); Michael Lydon, Hebron, CT (US); Denis Horgan, Kent, CT (US); Sean Campion, Lenexa, KS (US); Sarah C. Ramkissoon, North York (CA); Jessica C. Williams, Missoula, MT (US); George Tsipolitis, West Hartford, CT (US)

Correspondence Address: Goodwin Procter LLP, Patent Administrator, 53 State Street, Boston, MA, 02109-2881, US

(21) Appl. No.: 12/267,509

(22) Filed: Nov. 7, 2008

Related U.S. Application Data
(60) Provisional application No. 60/986,757, filed on Nov. 9, 2007.
(60) Provisional application No. 61/012,675, filed on Dec. 10, 2007.
(60) Provisional application No. 61/013,292, filed on Dec. 12, 2007.
(60) Provisional application No. 61/020,702, filed on Jan. 11, 2008.

(51) Int. Cl. G06Q 50/00; G06F 9/44; A63F 9/24; G06Q 10/00

(52) U.S. Cl. 705/7; 717/102; 463/9; 705/1; 705/11

(57) ABSTRACT

In general, in one aspect, a method for developing software by contest includes hosting a series of contests for the agile development of a software application by contest. In one embodiment, the method includes holding a contest for the development of a wireframe, holding a contest for the development of a static prototype, and holding a contest for the development of a working prototype. In some embodiments, the contests are repeated so as to iteratively modify the software application to better meet the customer's needs. In some embodiments, the working prototype is the final implementation of the software application. In some embodiments, a competition is held for the development of an application specification based on the working prototype.

### RELATED APPLICATIONS

This application claims priority to and the benefit of: U.S. Provisional Patent Application Ser. No. 60/986,757, to Hughes et al. entitled, SYSTEM AND METHOD FOR SOFTWARE DEVELOPMENT, filed on Nov. 9, 2007, attorney docket no. TOP-019PR; U.S. Provisional Patent Application Ser. No. 61/012,675 to Hughes et al., entitled SYSTEM AND METHOD FOR SOFTWARE DEVELOPMENT, filed on Dec. 10, 2007, attorney docket no. TOP-019P2; U.S. Provisional Patent Application Ser. No. 61/013,292 to Hughes et al., entitled SYSTEM AND METHOD FOR SOFTWARE DEVELOPMENT, filed on Dec. 12, 2007, attorney docket no. TOP-019P3; and U.S. Provisional Patent Application Serial No. 61/020,702 to Hughes et al. entitled SYSTEM AND METHOD FOR SOFTWARE DEVELOPMENT, filed on Jan. 11, 2008, attorney docket no. TOP-019P4.

### TECHNICAL FIELD

This invention relates to computer-based methods and systems for facilitating the development of software.

### BACKGROUND INFORMATION

Agile software development is a conceptual framework for software engineering. Software is developed in relatively short units of time (e.g., one week or one month), referred to as an iteration. Each iteration is a unit of a software project, in some cases including planning, requirements analysis, design, coding, testing, and documentation. Depending on the complexity of the application under development, an iteration may or may not add enough functionality to warrant an external release, but frequently a goal is to have releasable product that has additional or modified functionality at the end of each iteration. The customer (e.g., product manager, IT directory, or external customer) can evaluate the application at the end of each iteration, and request changes for the next iteration. In this way, the customer can see the working product as it develops and make changes along the way.

If a customer does not have access to a skilled agile development team, or if the customer's development team is not capable of the design and development requirements, the use of agile development may not be successful.

Further, some enterprise application developers criticize agile processes because they do not create code that is well-documented or maintainable. Typically, once an application has been finalized, the development team still has to rework code and create documentation, tasks that are often left undone when the code is working.

### SUMMARY OF THE INVENTION

As described in co-pending U.S. patent application Ser. No. 11/035,783, entitled SYSTEMS AND METHODS FOR SOFTWARE DEVELOPMENT by John M. Hughes, filed Jan. 14, 2005, incorporated herein by reference, a software application may be developed by contest, where the task of developing the software application is divided up into discrete tasks, and competitions are held for the performance of each of the discrete tasks. For example, the application architecture may be created in which the software application is divided into software components, and contests held for the design of the components. Contests also may be held for development of the designed components based on the winning designs.

As described in co-pending U.S. patent application Ser. No. 11/655,768, entitled SYSTEM AND METHOD FOR DESIGN DEVELOPMENT by John M. Hughes, filed Jan. 19, 2007, incorporated herein by reference, design contests may be held for example for graphics design and user interface development. Submissions in such contests may be evaluated for technical merit (i.e., meeting the described requirements) and/or based on customer affinity and/or appeal to a designated group of individuals.

As described in co-pending U.S. patent application Ser. No. 11/755,909, entitled PROJECT MANAGEMENT SYSTEM, by Messinger et al., filed May 31, 2007, incorporated herein by reference, a series of contests may be managed through use of project management system. Portions of a contest, such as a review effort, may begin when submissions are received, deadlines are met, and so on.

Contests may be used to create the look and feel of a software application, for example, by generating first a wireframe (e.g., a visual guide used to suggest layout and placement of fundamental design elements in the interface design), a static prototype (e.g., an implementation of the web site in HTML or other markup language but without data persistence or other functionality), and working prototypes (e.g., working implementations). By having a customer involved in the development of requirements for and selection of the deliverables, a contest-based development process results in the efficient creation of software. At any stage in the process, if a customer is not happy with the final results, the customer can hold another contest to revise the previous work product with new or changed requirements. This results in an agile-like process, but without the need to have a full-time team on staff.

In some embodiments, a series of contests may be held to develop a software application. The contests may be specified based on the desired characteristics of the software program. For example, if a working prototype is sufficient, one set of contests may be specified, and if a more robust, enterprise-quality application is desired, another set of contests may be specified. As another example, based on the application, one or more component competitions may not be needed. As another example, based on the simplicity of the application, a static prototype may not be needed.

In some embodiments, a contest may be held for the development of a wireframe depiction of an application based on high-level requirements, a contest may be held for the development of a static prototype based on the wireframe, and a contest may be held for the development of a working prototype based on the static prototype. In some embodiments, a contest may be held for the development of the high-level requirements based on input from the customer from documentation, form completion or interaction on a forum or by email.

In some embodiments, a project manager can compete for the opportunity to manage a project. The project manager may submit a proposal for pricing of the project and deadlines, or the project manager may be more of a manager, who helps oversee the development process and facilitates interaction with the contestants. In some such embodiments, the project manager produces a requirements document based on a high-level description from a customer. In some embodiments, the project manager is selected in a contest for the best proposal and/or based on previous work and rating. In some embodiments, the project managers compete for the selection of a project plan, the project plan specifying a series of competitions.

In some embodiments, the completion of a working prototype is the end of a first stage of application development. The working prototype may become an input into a second stage of contest development, in which a robust, high-quality software application is designed and developed based on the working prototype. The working prototype can be used as the basis for the development of a full requirements specification and/or for an enterprise-quality architecture design.

In some embodiments, the architecture design includes the specification of components, with some of the components already developed, for example, in a component library. After development of components is complete, the enterprise application may be assembled with one or more assembly competitions. Finally, in some embodiments, the application may be tested through one or more testing competitions, in which test cases are developed and run prior to deployment.

For some customers, a working prototype may be sufficient for their needs. They may simply deploy the working prototype, and maintain that code as their software application. For other customers, the working prototype, typically not designed for scale or maintainability, is just the first step, used to solidify a customer's requirements through the use of working code.

The systems described can be implemented as software running on computers and other devices, for example, as described in the above-referenced co-pending patent applications.

In general, in one aspect, a method for creating a deliverable comprising holding a series of on-line competitions using a competition management system, each of the competitions for the development of one or more assets, a number of which assets together comprise the deliverable, wherein each of the competitions to be held are selected based on the desired characteristics of the deliverable. The competitions may be selected from choices of competition types offered by the competition management system. The competitions to be held may be selected automatically based on the desired deliverable. The competitions to be held may be selected by an administrator and/or by a deliverable manager who has been engaged to assist with and/or oversee the competitions. The competitions may be selected from a list of types of competitions administered by a competition management system.

In some embodiments, a first series of competitions for development of assets may be specified and held, after which a second series of competitions may be held based on the list of competitions specified. Holding a competition may include specifying start date/time, end date/time, prize, and specification of the asset to be developed. In some cases, a customer for the deliverable may access the competition management system directly to request and initiate the series of competitions. In some cases, one or more of the assets are software designs, requirement descriptions, software components, user interface designs, etc.

In general in one aspect, a method for developing software includes holding a series of on-line competitions using a competition management system, wherein individuals compete against each other to develop and submit assets, which submissions are judged and a winner selected. The method includes holding one or more of: a competition for the development of an application specification in which a winning application specification is selected, holding an architecture competition for the development of application architecture based on the winning application specification in which a winning application architecture is selected, wherein the winning application architecture comprises specification of components, holding one or more component design competitions for a respective one or more of the specified application components in which a winning component design is selected in each component design competition, each respective winning design comprising component design documentation, holding component development competitions for development of components based on the winning designs, the components comprising an implementation of the winning design, and holding an assembly competition for assembly of the components specified in the winning application architecture in which a winning assembled application is selected. In some cases a testing competition for development of tests for testing of the winning application may be held. In some cases, competitions for the development of a wireframe in which a winning wireframe is selected, for the development of user interface design, and/or for the development of a static prototype based on a storyboard developed by competition, a wireframe developed by competition, or both, and the winning application specification. Competitions also may include competitions to translate or localize the asset, by holding competitions to translate/localize written text into one or more human languages other than the original language.

In general, in another aspect, a competition management system for holding a series of on-line competitions for developing software, is provided in which individuals compete against each other to develop and submit assets, which are then judged and a winner selected. The system may include an application specification competition subsystem for holding a competition for the development of an application specification in which a winning application specification is selected, an architecture competition subsystem for holding an architecture competition for the development of application architecture based on the winning application specification in which a winning application architecture is selected, wherein the winning application architecture comprises specification of components, and a component design subsystem for holding one or more component design competitions for a respective one or more of the specified application components in which a winning component design is selected in each component design competition, each respective winning design comprising component design documentation and a component development subsystem for holding component development competitions for development of components based on the winning designs, the components comprising an implementation of the winning design, and an assembly competition subsystem for holding an assembly competition for assembly of the components specified in the winning application architecture in which a winning assembled application is selected. The system also may include a creative design subsystem for holding a competition for the development of graphic design elements of the software application. The system also may include a user interface design subsystem for holding a competition for the development of user interface design. The system also may include a translation/localization competition subsystem for holding a competition for the translation of text into another human language.

In general, in another aspect, a method for developing software, comprising holding a series of on-line competitions using a competition management system includes holding a competition for the development of a wireframe, holding a competition for the development of a storyboard based on the winning wireframe, and holding a competition for the development of a static prototype based on the winning storyboard. In some embodiments, the storyboard includes a visual design for the software user interface. In some embodiments, a static prototype comprises a HTML prototype. In various embodiments, a competition may be held for any or all of the development of a working prototype, for an application based on the working prototype, for the development user interface elements based on the static prototype and an application programming interface specification, translation of the working prototype into another language, and so on. In some cases the competitions are judged by a customer, for example using an on-line scorecard, and in some cases reviewers are used, and they complete on-line scorecards to judge the competition.

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram illustrating by example an embodiment of a development contest.

FIG. 2 is a block diagram illustrating by example an embodiment of a contest-based software application development process.

FIG. 3 is an exemplary screen display of a dashboard according to an embodiment of the invention.

FIG. 4 is an exemplary screen display of a dashboard according to an embodiment of the invention.

FIG. 5 is an exemplary screen display of a dashboard according to an embodiment of the invention.

FIG. 6 is an exemplary screen display of a dashboard according to an embodiment of the invention.

FIG. 7 is a block diagram illustrating by example and embodiment of a contest-based software application development process.

FIG. 8 is a block diagram of a competition management system server according to an embodiment of the invention.

### DETAILED DESCRIPTION

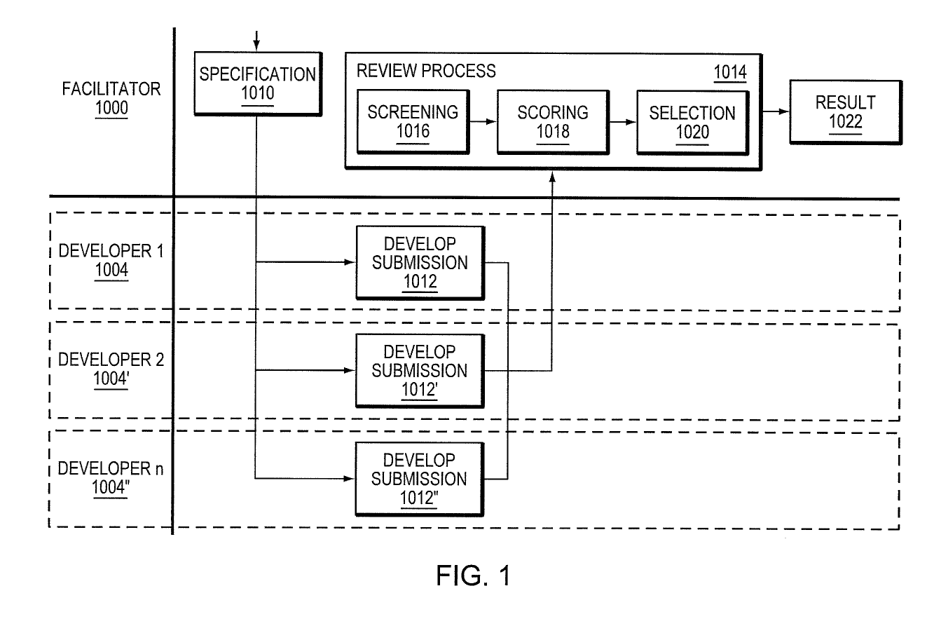

Referring to FIG. 1, in one embodiment, one possible generalized implementation of a contest for the development of an asset is shown. The asset may be any sort or type of asset that may be developed by an individual or group. As non-limiting illustrative examples, an asset may be a software program, logo, graphic design, specification, requirements document, wireframe, static prototype, working prototype, architecture design, component design, implemented component, assembled or partially-assembled application, testing plan, documentation, language translation, and so on.

In some embodiments, the development process is monitored and managed by a facilitator 1000. The facilitator 1000 can be any individual, group, or entity capable of performing the functions described here. The facilitator 1000 may be an administrator. In some cases, the facilitator 1000 can be selected from a the distributed community of contestants based on, for example, achieving exemplary scores on previous submissions, or achieving a high ranking in a competition. In other cases, the facilitator 1000 may be appointed or supplied by an entity requesting the development, and thus the entity requesting the competition oversees the competition.

The facilitator 1000 has a specification 1010 for an asset to be developed by competition. In general, a specification 1010 is intended to have sufficient information to allow contestants to generate the desired asset. In some cases, the specification 1010 may include a short list of requirements. In some cases the specification may include the result of a previous competition, such as a design, wireframe, prototype, and so forth. In some cases, the specification may be the result of a previous competition along with a description of requested changes or additions to the asset. The facilitator 1000 may review the specification 1010, and format or otherwise modify it to conform to standards and/or to a development methodology. The facilitator 1000 may in some cases reject the specification for failure to meet designate standards. The facilitator 1000 may mandate that another competition should take place to change the specification 1010 so that it can be used in this competition. The facilitator 1000 may itself interact with the entity requesting the competition for further detail or information.

The facilitator 1000 may specify rules for the competition. The rules may include the start and end time of the competition, and the awards(s) to be offered to the winner(s) of the competition, and the criteria for judging the competition. There may be prerequisites for registration for participation in the competition. Such prerequisites may include minimum qualifications, rating, ranking, completed documentation, legal status, residency, location, and others. In some cases, the specification may be assigned a difficulty level, or a similar indication of how difficult the facilitator, entity, or other evaluator of the specification, believes it will be to produce the asset according to the specification. Some of the specification may be generated automatically based on the type of competition.

The specification is distributed to one or more developers 1004, 1004′, 1004″ (generally, 1004), who may be members, for example, of a distributed community of asset developers. In one non-limiting example, the developers 1004 are unrelated to each other. For example, the developers may have no common employer, may be geographically dispersed throughout the world, and in some cases have not previously interacted with each other. As members of a community, however, the developers 1004 may have participated in one or more competitions, and/or have had previously submitted assets subject to reviews. This approach opens the competition to a large pool of qualified developers. As another example, the developers may be employed by or have a relationship with a particular entity.

The communication can occur over a communications network using such media as email, instant message, text message, mobile telephone call, a posting on a web page accessible by a web browser, through a news group, facsimile, or any other suitable communication. In some embodiments, the communication of the specification may include or be accompanied by an indication of the rules including without limitation the prize, payment, or other recognition that is available to the contestants that submit specified assets. In some cases, the amount and/or type of payment may change over time, or as the number of participants increases or decreases, or both. In some cases submitters may be rewarded with different amounts, for example a larger reward for the best submission, and a smaller reward for second place. The number of contestants receiving an award can be based on, for example, the number of contestants participating in the competition and/or other criteria. Rewards may be provided for ongoing participation in multiple competitions, for example as described in co-pending U.S. patent application Ser. No. 11/410,513 to Hughes et al., filed May 1, 2006, entitled System and Method for Compensating Contestants.

The recipients 1004 of the specification can be selected in various ways. In some embodiments all members of the community have access via a web site. In some embodiments, member may register for a contest to gain access. In some embodiments, members of the community may have expressed interest in participating in a particular type of development competition, whereas in some cases individuals are selected based on previous performances in competitions, prior projects, and/or based on other methods of measuring programming skill of a software developer. For example, the members of the community may have been rated according to their performance in a previous competition and the ratings may be used to determine which programmers are eligible to receive notification of a new specification or respond to a notification. The community members may have taken other steps to qualify for particular competitions, for example, executed documentation such as a non-disclosure agreement, provided evidence of citizenship, submitted to a background check, and so forth. Recipients may need to register for a competition in order to gain access.

In one embodiment, a facilitator 1000 moderates a collaborative discussion forum among the various participants to answer questions and/or to facilitate development by the contestants. The collaborative forum can include such participants as facilitators, developers, customers, prospective customers, and/or others interested in the development of certain assets. In one embodiment, the collaboration forum is an online forum where participants can post ideas, questions, suggestions, or other information. In some embodiments, only a subset of the members can post to the forum, for example, participants in a particular competition or on a particular team.

Upon receipt of the specification 1010, one or more of the developers 1004 each develop assets to submit (shown as 1012, 1012′ and 1012″) in accordance with the specification 1010. The development of the asset can be done using any suitable development system, depending, for example, on the contest rules and requirements, the type of asset, and the facilities provided. For example, there may be specified tools and/or formats that should be used.

Once a developer 1004 is satisfied that her asset meets the specified requirements, she submits her submission, for example via a communications server, email, upload, facsimile, mail, or other suitable method.

To determine which asset will be used as the winning asset as a result of the contest, a review process 1014 may be used. A review can take place in any number of ways. In some cases, the facilitator 1000 can engage one or more members of the community and/or the facilitator and/or the entity requesting the asset. In some embodiments, the review process includes one or more developers acting as a review board to review submissions from the developers 1004. A review board preferably has a small number of (e.g., less than ten) members, for example, three members, but can be any number. Generally, the review board is formed for only one or a small number of related contests, for example three contests. Review boards, in some embodiments, could be formed for an extended time, but changes in staffing also can help maintain quality. In some embodiments, where unbiased peer review is useful, the review board members are unrelated (other than their membership in the community), and conduct their reviews independently. In some embodiments, reviewers do not know the identity of the submitter at the time that the review is conducted.

In some embodiments, one member of the review board member is selected as a primary review board member. In some cases, a facilitator 1000 acts as the primary review board member. The primary review board member may be responsible for coordination and management of the activities of the board.

In some embodiments, a screener, who may be a primary review board member, a facilitator, or someone else, screens 1016 the submissions before they are reviewed by the (other) members of the review board. In some embodiments, the screening process includes scoring the submissions based on the degree to which they meet formal requirements outlined in the specification (e.g., format and elements submitted). In some embodiments, scores are documented using a scorecard, which may be a document, spreadsheet, online form, database, or other documentation. The screener may, for example, verify that the identities of the developers 1004 cannot be discerned from their submissions, to maintain the anonymity of the developers 1004 during review. A screening review 1016 may determine whether the required elements of the submission are included (e.g., all required files are present, and the proper headings in specified documents). The screening review can also determine that these elements appear complete.

In some embodiments, the screening 1016 includes initial selection by the entity that requested the competition. For example, if the competition is for a wireframe, the entity may select the wireframes that seem to be the best. This smaller group may then go on to the next step.

In some embodiments, the screener indicates that one or more submissions have passed the initial screening process and the reviewers are notified. The reviewers then evaluate the submissions in greater detail. In preferred embodiments, the review board scores the submissions 1018 according to the rules of the competition, documenting the scores using a scorecard. The scorecard can be any form, including a document, spreadsheet, online form, database, or other electronic document. There may be any number of scorecards used by the reviewers, depending on the asset and the manner in which it is to be reviewed.

In some embodiments, the scores and reviews from the review board are aggregated into a final review and score. In some embodiments, the aggregation can include compiling information contained in one or more documents. Such aggregation can be performed by a review board member, or in one exemplary embodiment, the aggregation is performed using a computer-based aggregation system. In some embodiments, the facilitator 1000 or a designated review board member resolves discrepancies or disagreements among the members of the review board.

In one embodiment, the submission with the highest combined score is selected as the winning asset 1020. The winning asset may be used for implementation, production, or for review and input and/or specification for another competition. A prize, payment and/or recognition is given to the winning developer.

In some embodiments, in addition to reviewing the submissions, the review board may identify useful modifications to the submission that should be included in the asset prior to final completion. The review board documents the additional changes, and communicates this information to the developer 1004 who submitted the asset. In one embodiment, the primary review board member aggregates the comments from the review board. The developer 1004 can update the asset and resubmit it for review by the review board. This process can repeat until the primary review board member believes the submission has met all the necessary requirements. In some embodiments, the review board may withhold payment of the prize until all requested changes are complete.

In some embodiments, a portion of the payment to the developer 1004 is withheld until the until after other competitions that make use of the asset are complete. If any problems with the asset are identified in the further competitions, these are provided to the reviewer(s) and the developer 1004, so that the requested can be made by the developer 1004.

There also may be prizes, payments, and/or recognition for the developers of the other submissions. For example, the developers that submit the second and/or third best submissions may also receive payment, which in some cases may be less than that of the winning contestant. Payments may also be made for creative use of technology, submitting a unique feature, or other such submissions. In some embodiments, the software developers can contest the score assigned to their submission.

It should be understood that the development contest model may be applied to different portions of work that are required for the development of an overall asset. A series of development contests is particularly suitable for assets in which the development may be divided into stages or portions. It can be beneficial in many cases to size the assets developed in a single competition such that work may be completed in several hours or a few days. The less work required to develop a submission, the lower the risk for the contestants that they will not win, and increased participation may result.

As an example of a competition that may be used for support, not intended to be limiting, in some embodiments, a prize value may be assigned to an identification of a fault, and the fault identification published or otherwise made available to competitors for fault repair. In some embodiments, fault repair takes place as a result of a fault identification competition, for example as described in co-pending U.S. Provisional Patent Application Ser. No. 61/051,676, filed May 8, 2008, entitled SYSTEM AND METHOD FOR CONDUCTING COMPETITIONS, attorney docket no. TOP-022PR. Fault identifications may be published to competitors, and the competitor that fixes the fault and submits the repair wins.

During the repair competition, submissions are received from competitors containing a repair to the identified fault. The repair may be in the form of a modified software program, which may include one or more of patches to the code, updated code, an entire source code distribution, scripts to modify the software, test cases to test the repair, and so on. Any suitable submission may be used. In some cases, submissions may be provided using a bug tracking system in which the repair can be submitted as an attachment and/or a comment to the issue listing for the fault.

The fault repair submissions may be verified. In some embodiments, competition administrators and/or a designated review board verify that the fault has been repaired. In some embodiments, competition competitors have the opportunity to attempt to verify, or prove incorrect, the repaired faults. In some embodiments, a customer or other person, entity, or group with an interest in the software program verifies the repair. In some embodiments, a repair is considered to be verified if it is verified by a predetermined number of competitors. Repair verification may include any combination of such verification.

In some embodiments, competitors can gain points and/or prizes by verifying repairs identified by other competitors. In one such embodiment, after a first competition phase in which competitors submit repairs, a second competition phase is held in which competitors attempt verify the repairs submitted by others. Competitors may gain points and/or prizes for each repair that is verified, and may gain points and/or prizes for each repair submission that is shown not to completely correct the fault, or to introduce a different fault. In some embodiments, in which submissions are made available to competitors as they are submitted, the repairs can be submitted and verified during a single phase of competition, and competitors can choose whether to try to submit repairs or to verify existing repairs, depending on the points/prizes offered and their anticipated likelihood of success.

For the repair competitions, the assigned prize value may be awarded to the winner. It may be that an additional prize, or a portion of the prize is awarded to a runner-up, or to a competitor who verifies the fix, and so on. By putting the proper incentives in place, the distributed community of developers can have coordinated efforts in finding and fixing faults in software programs.

In some embodiments, points may be earned by participating and/or placing in one or more competitions may be combined and used to allocate a prize pool (e.g., a pool of prize money or other benefits to be divided among a group of competitors). For example, the prize pool may be allocated proportionally to the points awarded. In some cases, additional prizes (from the pool or otherwise) may be assigned to highly-placed point winners (e.g., first place, second place), and so on. The allocation of points may be combined with some monetary or other reward, in order to create both short-term and long-term incentives. Points may be combined for a specific number of competitions, or for competitions of a type or types during a particular time period. There may be a prize pool for a subgroup or time period, and another prize pool for a superset of multiple subgroups or time periods. The allocation of points and the awarding of prizes may be determined by an award subsystem on the server.

In various embodiments, some competitions may award a prize to the best submission, as judged by objective criteria, other competitions may award a prize to the first submission that sufficiently met requested criteria, and still other competitions award a prize to the submission that is most appealing, for example, based on stated criteria or the stated preference of specified individuals. The various types of competitions may be selected, for example, based on the competition objectives and the availability of objective criteria, the cost/benefit of having reviewers conduct a review, and the complexity of the task to be performed by competition. In any case, the holding of a competition adds the element of competition to each stage of the process.

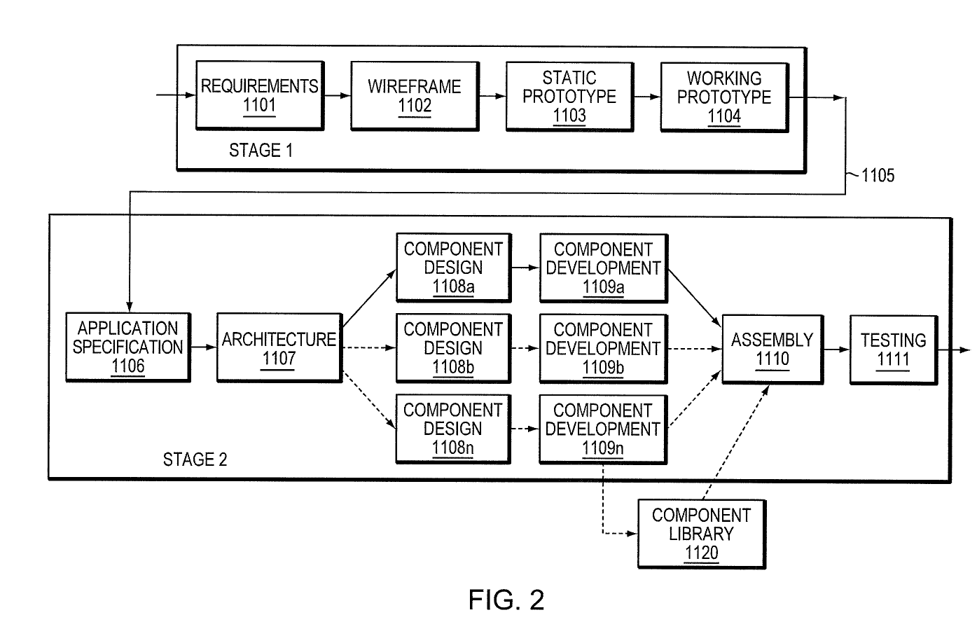

Referring to FIG. 2, in one illustrative example, steps for development of a software application are shown. While the illustrative example presented is a web application, it should be understood that any sort of software application, with any type of architecture, including without limitation mobile applications, client/server applications, thin-client applications, to give a few examples, may be suitable for this type of development process.

A series of contests may be held to develop the software application. For example, a person, referred to as a customer, may have an idea or concept for a software application. The idea may be, for example, thought-out in detail or only with a high level of description. A series of development competitions (for example as shown with respect to FIG. 1) may be held, starting with the concept. For example, a contest may be held for the development of application requirements 1101. In such a contest, the initial description and documentation provided by the customer may be used as part of the contest specification 1010 (FIG. 1). The asset to be developed in the competition is requirements documentation. It may be that the contestants need to interact with the customer to develop the requirements. Typically, this interaction would take place on a forum that is open to all of the contestants. The review of the requirements may involve one or more peer reviewers (i.e., members of the contestant community) and/or the customer. The selection of a requirements document may be based on the degree to which it represents the concept presented, the actual desires of the customer, and technical understanding and feasibility.

In some embodiments, the application requirements competition 1101 uses a questionnaire, such as an electronic document, that has been completed by the customer. The questionnaire may include questions such as provided in TABLE 1. The objective of these questions is to provide enough information for contestants to start asking questions and develop a specification submission.

TABLE 1
EXAMPLE QUESTIONNAIRE

| | Instructions |
|---|---|
| | The purpose of this questionnaire is to help TopCoder learn how your new application |
| | should operate to best address your need, problem or opportunity. We'll ask you to |
| | describe your current process, and identify your main needs or opportunities. We'll |
| | also ask questions about the sort of technical environment the new application should |
| | expect, and what features the new application should include. |
| | What this Document is Not: This Questionnaire is just a starting place - it is not a |
| | formal requirements specification. After you or your team complete this document, |
| | you or your project manager will compile responses and post them to competition. |
| | The competition includes a lengthy question-and-answer period with you that will |
| | flush out details and exceptions. Your responses to this document will be used to start |
| | the process of creating a prototype and writing a formal requirements specification for |
| | your desired application. |
| | What You Need To Do |
| | Please answer the questions below. If you would like to include drawings or |
| | diagrams to make your point better or easier, please feel free. Screenshots are always |
| | helpful too, if available. You can answer questions directly in this document, or |
| | include attachments with your responses if you need more space. |
| | When you're done, please email the Questionnaire to the address provided |
| | Concept |
| 1. | If you are planning to replace an existing application or business process, please |
| | describe the process below. Or, if you are creating an application to take advantage of |
| | an opportunity, please describe it here as well. If you wish, include a diagram that |
| | illustrates the steps and systems that are involved in the process. In this section, you |
| | are “telling the story. |
| 2. | Broadly speaking, who is involved with the data or application? (Please briefly |
| | describe the roles of people who will be involved or affected and the information that |
| | they will provide or receive.) |
| 3. | What information do you need to feed into the system to complete the process |
| | (system input)? For example, do you need to key in customer account numbers or |
| | names? Is there a list of shopping cart items? |
| 4. | What are the outputs of the system? For example, does the application charge the |
| | customer and print a receipt? Does it update another system? |
| 5. | Does the application or process depend on other systems, documents or people? If so, |
| | name and briefly describe them here. |
| 6. | Are there shortcomings to the current system? If so please list and describe them |
| | here. |
| 7. | If your system or process is comprised of different modules, please briefly describe |
| | them here. For example, are there modules or screens that are used only for |
| | maintenance? |
| 8. | Please list any reports that are produced by the system. |
| 9. | Is there anything else about the application that you'd like people to know? This is |
| | the place to address any functionality, problems, opportunities, risks, etc. that didn't |
| | “fit” in earlier questions. |
| | Business Requirements |
| 10. | Why are you taking the time to build this application? What are the expected |
| | benefits? What features will indicate success? |
| 11. | What will the inputs to the system be? For example, what data or resources do the |
| | users or the system need in order to start the process? |
| 12. | What are the expected outputs from the system? (Outputs can include printed reports, |
| | receipts, modified displays, electronic data feeds to external systems, etc) |
| 13. | Please describe the ideal task flow of the new application; how should it work? Begin |
| | with the inputs and end with the outputs. In this section, you should exclude the |
| | exceptions that might occur. |
| 14. | If possible, please describe the reasons why the path above can fail (or fails today). |
| | This could include time or resource limitations, problems with data relationships, |
| | other glitches, etc. |
| 15. | Is this a new system, or an upgrade to an older one? |
| 16. | Approximately how many users will be using the application? |
| 17. | How many users will be on the application concurrently? |
| 18. | Will any users be using the system from different timezones? |
| 19. | Will the system need to receive feeds from external systems? If so, please name |
| | them, if possible. Include a description of the data that must be transferred, and the |
| | form it must be transferred in (e.g. email, paper, electronic feed, etc) |
| 20. | Will the system need to receive feeds from external systems? If so, please name |
| | them, if possible. Include a description of the data that must be transferred, and the |
| | form it must be transferred in (e.g. email, paper, electronic feed, etc) |
| 21. | Will the system need to send feeds to external systems? If so, please name them, if |
| | possible. Include a description of the data that must be transferred, and the form it |
| | must be transferred in (e.g. email, paper, electronic feed, etc) |
| 22. | Is the system expected to send or receive email? Under which conditions? |
| 23. | Is the system expected to operate with any peripheral devices besides a printer? For |
| | example, will the application be required to support fingerprint scanners, barcode |
| | guns, touchscreens, tablets, RFID, etc. |
| 24. | Please describe the computer resources the designers should expect of the users. For |
| | example, will every user have a PC, or should the application be a “green-screen” |
| | app? Do users have keyboards and mice? Will users have internet access? |
| 25. | Do users have specific GUI needs of the application? For example, should the |
| | application support “heads-down” or “cash register” style usage? |
| 26. | Please describe some new features that you would like to see the system include. |
| 27. | Should the system require the user to log in? |
| 28. | Is there a “central authority” that manages user's accounts that this system should |
| | “talk” to? If so, please name or describe it if possible. |
| 29. | Are there special auditing needs for user's activity on this application? |
| 30. | Will the user be working directly with financial or other protected information, like |
| | health records and classified data? |
| 31. | Should the application be networked or stand-alone? Browser-based or thick-client? |
| 32. | Is there a particular language or platform on which the system must be built? |

In some embodiments, the format of the specification document is specified. Preferably, a model and/or outline document is provided so that the competitors can understand what the expected format of the specification document is. In some embodiments, the specification document has an outline such as in TABLE 2. It should be understood that this is exemplary, and other suitable specification formats may be used.

TABLE 2
SPECIFICATION OUTLINE

| | |
|---|---|
| 1.0 | Introduction |
| | 1.1 Scope of Application |
| | 1.2 Project Objectives |
| | 1.3 Success Criteria |
| | 1.4 Assumptions |
| | 1.5 Limitations |
| | 1.6 Risks |
| 2.0 | Existing Business Flow |
| | 2.1 Context Diagram |
| | 2.2 High Level Workflow |
| | 2.3 Tasks Description |
| | 2.4 Dependencies |
| | 2.5 Current Limitations/Problems |
| 3.0 | Proposed Workflow |
| | 3.1 Context Diagram |
| | 3.2 High Level Workflow |
| | 3.3 Task Description |
| 4.0 | Business Requirements |
| | 4.1 Users |
| | 4.2 Inputs/Outputs |
| | 4.3 Dependencies |
| | 4.4 User Requirements |
| | 4.5 Security Requirements |
| | 4.6 Performance Requirements |
| | 4.7 Data Migration |
| 5.0 | System Requirements |
| | 5.1 User Permissions |
| | 5.2 Hosting Technology |
| | 5.3 Integration Targets |
| | 5.4 Backup & Recovery |

In some embodiments, a scorecard also is provided, so that the competitors understand the criteria under which their specifications will be judged.

The requirements documentation that is developed in the requirements contest 1101 may then be used as part of the contest specification 1010 (FIG. 1) for a wireframe competition 1102. The wireframe contest 1102 may be held for the development of a wireframe (e.g., a visual guide used to suggest layout and placement of fundamental design elements in the interface design) of the application. The wireframe typically lays out the interface of the application, and presents visually the way that a user will interact with the application software. The review of the wireframes may involve one or more peer reviewers (i.e., members of the contestant community), as well as the customer. The selection of a wireframe may be based on the degree to which it implements the requirements, the actual desires of the customer, and technical understanding and feasibility.

When a wireframe contest 1102 is complete, a contest may be held for the development of a static prototype 1103 (e.g., an implementation of a web site in HTML or other markup language, typically without data persistence or other server-based functionality) using the wireframes as a starting point. The static prototype typically shows screen displays as they would look in the application, but does not have implemented functionality. The review of the static prototype may involve one or more peer reviewers (i.e., members of the contestant community) and/or the customer. The selection of a static prototype may be based on the degree to which it implements the requirements, the actual desires of the customer, and technical understanding and feasibility.

When the static prototype contest 1103 is complete, a contest 1104 may be held for the development of working prototypes (e.g., working implementations) based on the static prototype(s). A working prototype typically has code that implements the requirements, wireframes, and static prototypes, along with any other comments or instructions provided by the customer. This working prototype may have certain restrictions or requirements that are described in the contest specification 1010 (FIG. 1). The working prototype may not need to be highly scalable, for-example, or enterprise quality code, but merely good enough for a user to try and use.

By having a customer involved in the requirements for and selection of the deliverables, a contest-based development process results in the efficient creation of software that the customer is happy with. At any stage in the process, if a customer is not happy with the final results, the customer can hold another contest, to review or revise the previous work product with new or changed requirements.

The working prototype may be sufficient for some customers 1105 as a useful application. For others, the working prototype is a first step for confirming the desired requirements for a software application. Once they have used and tested the functionality of the working prototype, the working prototype may be used as the input to another series of competitions for development of an enterprise quality software application.

Shown as “STAGE 2” in the figure, another series of contests, beginning with the development of an application specification 1106 based on the working prototype may be held. In some such embodiments, a contest for development of an application specification 1106 may be held. The contest specification 1010 (FIG. 1) may include the winning working prototype and information about changes requested from the working prototype. Other information that may be included in the contest specification 1010 (FIG. 1) may include the required format and scope of the application specification. In one embodiment, the application specification is a requirements specification, including screen displays, functionality description, and so forth. A customer may participate on a review board for a specification, particularly to fill in any gaps, or to clarify any problems with the inputs to the specification competition. Of course, the specification competition could be held without a working prototype (if STAGE 1 is skipped) or just using wireframes and/or static prototypes as input. Likewise, a customer may just develop its own specification, and/or engage a consultant to develop a specification.

Once the winning application specification is selected, it may be used as the contest specification 1010 (FIG. 1) for an architecture competition. The asset(s) that may be developed as part of the architecture competition may include an overall architectural design, as well as a description of components that may be used to build the application. An architectural design may include a description of new components that may be built as part of other competitions 1108, 1109, or as existing components from a component library 1120. When a winning architecture is selected, the resulting component specification(s) may be used an input for component design competition(s) 1108. A customer may participate on a review board for an architecture competition, particularly if the customer has architecture expertise. The customer may be particularly interested in the interfaces and integration with its other systems. Typically, it is useful to have skilled architects working on the review board for an architecture competition, to identify technical issues with the architectural design.

In some embodiments, the components specified in the winning architecture may be developed by holding a series of component design competitions 1108. The winning component designs are then used as input for component development competitions 1109. As illustrative examples, component design and development competitions have been described, for example, in the above-referenced U.S. patent application Ser. No. 11/035,783. When all components have been completed, they may be assembled in assembly competitions 1110. Finally, test scripts may be developed, tested, and run in testing competitions 1111. At the completion of STAGE 2, an enterprise-ready software application that meets the requirements is completed.

In some embodiments, reusable assets may be provided to increase the speed of development in each of the various stages. For example, templates, graphics, tools, design patterns, and so forth may be used to increase the productivity of the contestants, and to give a common style to make evaluation and integration easier.

It should be understood that one, two, or more of the steps may be performed in a different order, or combined or omitted. For example, in STAGE 1, there may not be a need for a requirements competition 1101. Rather, the contestants in the wireframe may start from the description provided by the customer, and ask questions in a forum or otherwise to generate their wireframes, without use of more formal requirements documentation. Likewise, there may be at any stage multiple competitions and/or multiple levels of competitions. For example, for a complex application, there may be an overall architecture design, and then individual competitions for the architecture design of subassemblies. The architecture of the subassemblies may be designed, needed components built, and the subassemblies assembled. The subassemblies may then be assembled into complete application in an additional competition or competitions. Testing competitions may be held for various portions of an application, for example, for a subassembly, or for a distinct portion of an application, such as a user interface with another competition held for testing of back-end functionality.

It also should be understood that development by a series of contest is flexible, in that contests can be repeated if the results were not as expected, or if additional changes or new functionality is desired. Likewise, a customer can undertake as much work as it likes through development by other methods, for example, by using internal staff or outside consultants. For example, rather than holding a contest 1104 for a working prototype, a customer can take the static prototype, and develop the working prototype itself.

In some embodiments, where the assets developed outside of the contest environment are being used as the input to another contest, it may be useful to engage reviewers to review the asset. For example, a static prototype review can be conducted on a static prototype developed by a customer before that static prototype is used as input to the working prototype contest 1104. As another example, in STAGE 2, an entity might develop a specification itself, engage reviewers to review the specification, then use the specification in a contest for some or all of the architecture, hold a contest for development of some or all of the components, and then assemble the application itself. A review can be conducted on the assembly, and a testing competition held to develop test scripts and other functionality.

In some embodiments, a “project plan” competition may be held prior to the competitions described. In the project plan competition, competitors develop a plan for development of the customer's project needs. For example, the plan may specify a series of development contests and timeframes for developing the desired software application. The plan may provide approximate costs, based on historical or other data, for similar competitions. The plan may include development strategies, and assumptions about customer participation. A project plan may be specified as a series of competitions, which may then be monitored through interaction with a competition management server. One asset developed in such a plan may be a configuration of contests as specified in a project management system, such as that described in co-pending U.S. patent application Ser. No. 11/755,909. The winner of the project plan competition may be selected as a deliverable manager, as described further below.

In one embodiment, a competition web site provides a registration process for a development project. Following project registration, a customizable dashboard, or “cockpit” is configured with a variety of functional widgets with which a customer can begin the process of having development work done by a member community. The customer can launch competitions and track projects through delivery and member payment. In some embodiments, the web site project-specific public or private ‘group’ pages, generated by the customer from the cockpit, on which the nature of the project can be described, relevant attachments can be viewed, and the customer can openly communicate with members via a bulletin board or forum to answer questions, receive suggestions, and so on. In some embodiments, these pages allow participants to see the evolution of the project, interact, collaborate, provide status reports, and make delivery.

In some embodiments, representatives of a customer, and members in different roles, may have access to different capabilities for the project. For example, some customers may be able to post projects, while others may only be able to review status, and other review and approve payments.

In some embodiments, a dashboard page serves as an entry point for customers to interact with the TopCoder Community. From this dashboard page, a registered customer may launch and track projects, send and receive messages and monitor a variety of information sources. The dashboard may include a profile box with information about the individual, and a link to other information, or to update the information, a button that allows the launching of a project, a button or link for help and “how-to” information, navigation to other pages, such as contests and discussion forums, and in some cases space for broadcast messages or advertising, search field, and so forth. In some implementations, the page is customizable, with a framework allowing for “widgets” to be dragged and dropped into place into a user-configured order.

In some embodiments, the dashboard includes a widget that provides information about the user's projects, which maybe updated dynamically, such as the project name, the status of the project, the name of the personnel associated with the project, the status of the project, the status of payments, the number of contest participants, the number of submissions, the project phase, whether there are new forum posts (and in some cases, information or a link to the post(s)).

In some embodiments, the dashboard includes a messaging widget that indicates whether new messages are waiting, and allows a user to compose new messages. In some embodiments, a team widget shows information about individuals who are working on a current project, or, for example, a past project, or have been designated for another reason to be included. An RSS feed widget provides an indication of whether content has been added to a particular web page. A news widget provides information about new features, or, for example, newly-available components that may be used in a competition.

Project Managers

The flexibility provided by maintaining multiple entry and exit points into and out of the development process allows customers to decide, on a case by case or phase by phase basis whether to utilize the contest system from start to finish, (e.g., requirements 1101 through working prototype 1104, and specification 1106 through testing 111) or only use the specific contests.

In some embodiments, a facility that provides development competitions serves as a “force multiplier” for a project manager, allowing the project manager can single-handedly oversee the development of an application for a customer. In some embodiments, a market for project managers is provided that allows project managers to meet customers. The project managers work with the customers to help them get their projects done. The projects managers can explain the process, help customers formulate and execute the competitions, and communicate feedback to the developers during the competitions.

In some embodiments, a project manager can compete for the opportunity to manage a project. A project manager may submit a proposal for pricing of the project and deadlines, and/or the project manager may propose his services as a manager to help guide the development process and facilitate interaction with the contestants. In some such embodiments, the project manager produces a requirements document based on a high-level description from a customer. In some embodiments, the project manager is selected as part of a contest for the best proposal judged by the customer, one or more reviewers, or both.

Automated Requirements Gathering

In some embodiments, automated tools are used to help gather requirements from a customer. For example, prior to or during a requirements competition 1101, a wireframe competition 1102, an application specification competition 1106 and/or an architecture competition, a customer may be directed to an automated tool that solicits information from the customer about the desired software application. In some cases, the automated tool may request information about the software application based on information previously provided by the customer. For example, if the customer has indicated that the system is to be implemented in Java, the automated tool may ask whether particular Java-based frameworks may be used. In some cases, the automated tool may request information from the customer based on an indication from contestants and/or reviewers that there is information that has not been provided. For example, if the customer has not indicated a preference for a color scheme, the tool may be notified, and the customer may receive a request to visit a web site for the automated tool, where the customer will be directed to select colors for the software application user interface (e.g., colors for icons, text, etc.).

In some embodiments, information for an initial requirements document may be solicited from a customer using such an automated tool. The automated tool may allow the customer to interact with the tool, to identify and complete information about the software application that has not yet been provided.

In some embodiments, the automated tool is used to help a customer (or a project manager) develop a project plan in response to questions asked and information gathered by the automated tool. For example, the tool may suggest a particular series of competitions and/or adjustments to order or number of competitions in response to answers provided by a customer (or a project manager).

In some embodiments the requirements for an asset (e.g., a software program or other product) are specified, by providing an providing an electronic form on a competition management system for completion by a customer, the form specifying information about a desired asset. The completed form is provided to competitors in a competition to define the requirements for the asset. The competition management system also has a communications forum, such as a message board, message wall, blog, comment page, and so on, which can be used by the competitors and the customer for discussing the information in the electronic form and the customer's desired requirements before and during the competition. A competition is conducted via the competition management system for the development of a requirements specification for the asset based on the electronic form and the communications forum, in which competitors each submit a requirements specification and the customer may select the winning specification based, for example, on the degree to which the specification accurately represents the requirements. A technical review of the specification also may be conducted to determine that the specification also meets technical requirements. In some cases, changes to the specification may be required by a technical review and/or the customer prior to payment.

In some embodiments, a request is received at a competition management system to conduct a competition for the development of an asset. The competition system provides an electronic form for completion by the customer, the form specifying information about the desired asset. A competition type may be designated based on the information provided by the customer in the completed electronic form and the competition rules may be designated based on the competition type. One or more competitions may be conducted based on the information in the electronic form, which may include for example, information about the asset, prizes to be offered, desired deliverables, and so on.

Architecture Competitions

Referring again to FIG. 2, in some embodiments, an architecture competition 1107 may be held using a static prototype, working prototype, and/or a requirements specification as (all or part of) the specification for the competition. The architecture competition typically is for the design of an application, or a portion of an application (e.g., a subassembly). Details about the competitions, such as the specification(s) and required deliverables may be provided to potential contestants. The specifications provided may be in summary form, and certain prerequisites (e.g., execution of certain agreements, certifications, etc.) required for registration and access to additional specification documents. Contestants can review the available documentation, prize amounts, and timelines, and decide whether they would like to compete. Once registered, a contestant may have access to forums and/or other information related to the competition.

During the competition, contestants create an application architecture based on the specification documentation provided. Contestants may be required to create diagrams, such as UML diagrams (e.g., sequence diagrams), to demonstrate messages through the system. Such diagrams may be used as a roadmap for assembly, for example during an assembly competition. Contestants may be required to generate an architecture specification document to describe the architecture.

In some embodiments, contestants also include in their submissions a simple proof-of-concept of the application. This may include a minimal-functionality system to which more functionality may be added incrementally. This may include a simple front-end user interface, system services, and simple, but usable output. Generally, this will allow the client, end user, customer and/or reviewer to see visually what the software as designed will do, and understand what it will look like and act like. The proof-of-concept may be a so-called walking skeleton, demonstrating a subset, typically, the selected as the most important or the most demonstrative subset of user interface input, system services, and simple, but usable output. The user interface, for example, may be simple in layout, and not include all fields. Some validations of client input may be made, but typically not all, some functionality may be implemented, and some output produced.

In some embodiments, the proof-of-concept is a modification of a working prototype that is provided to all contestants, for example as the winning result of a previous competition 1104. In some embodiments, the proof-of-concept is generated by the architect from a requirements document. In some embodiments, the proof-of-concept may include one or more previously-build components specified in the architecture, so as to give some indication of how those components will work together, and some very simple functionality to simulate one or more components to be built. The generation of the proof-of-concept prototype may be useful for the assembly phase, because it will demonstrate how the assembled software should look and act.

Contestants may be required to identify components that may be used to build the specified system. The components may already exist, for example in a component catalog or library, or the components may need to be developed. Specification of interfaces between the application and the components may be required. Specifications for new components may be required, such specifications sufficient to be used as the basis for component design competitions.

During the review phase of the architecture competition, each contestant's submission is reviewed using a scorecard. There may be one, two, three, or more reviewers. The scores on the scorecard are used to determine which of the submissions best meet the deliverables laid out in the specification. An appeals and appeals response stage may follow scorecard review, in which contestants can review their scores and appeal a review statement. In some embodiments, the appeal can be lodged only for statements that are factually incorrect. Reviewers respond to the contestant's appeals, and any unresolved questions may be reviewed and decided by an administrator. When all appeals have been settled, a winner (and is some cases, one or more runner-ups) may be determined.

In some embodiments, a winner makes corrections specified by the reviewers, and those corrections may be verified by the reviewers. When identified bugs and reviewer comments have been addressed, prizes may be awarded.

In some embodiments, in addition to creating specifications for new components, the winner of an architecture competition launches contests for the development of the application specified by the winning architecture design. For example, for components that were specified, but not developed, the winner of the architecture competition launches the competitions for those components, and participates in management of such competitions. The architecture competition winner may answer questions and/or provide other information to the participants in the component competitions. In such cases, a portion of the prize may be withheld until after the winner has successfully supported all new component design competitions.

In some embodiments, the winner of an architecture competition launches contests for the assembly of an application based on the architecture specification. The assembly may include new or existing components. The architecture competition winner may answer questions and/or provide other information to the participants in the assembly competitions. A portion of the architecture competition prize may be withheld until after the winner has successfully supported all such competitions.

For example, in some embodiments, a first place winner in an architecture competition may be awarded a portion (e.g., 60%) of the prize upon completion of the changes indicated by reviewer comments. The remaining portion (e.g., 40%) of the prize is awarded after the first place winner has successfully supported all new component design competitions, development competitions, and assembly competitions that are required to develop the architected software. Any other suitable percentage apportionment may be used, for example, 80/20, 70/30, 55/65, or 50/50. A greater number of divisions may be used as well, for example, a portion (e.g., 40%) at completion of changes to the architecture, another portion (e.g., 30%) at the completion of component competitions, and another portion (e.g., 30%) at completion of assembly. Any other suitable breakdown of prizes may be used.

In some embodiments in which a working prototype is not developed prior or during architecture, a working prototype may be developed by competition prior to component development competitions. In some such embodiments, the winning architect is also responsible for managing a competition for the development of the working prototype. Further work (and any withheld prize money) may be contingent on customer/end-user sign-off on the working prototype, once developed. In this way, a customer can see and agree to what they are having developed before a significant portion of the development work takes place.

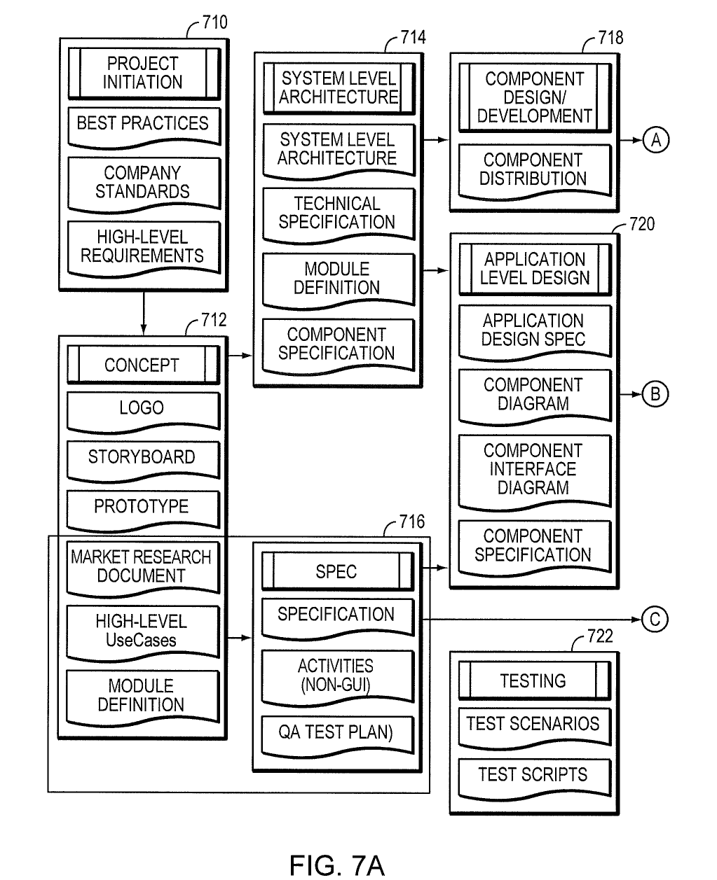

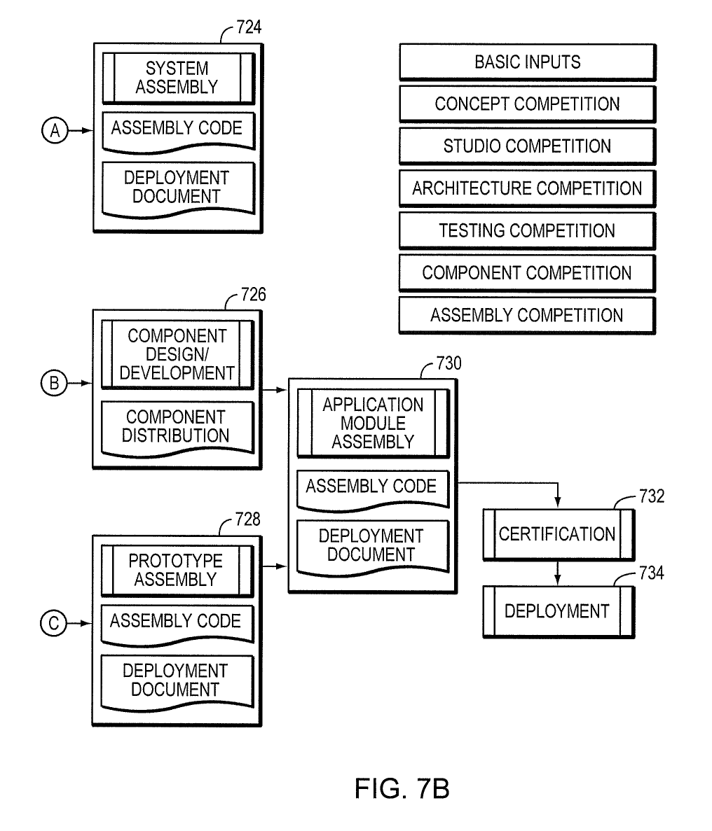

Referring to FIG. 7, in some embodiments, a project workflow includes a number of stages 710-734 and deliverables, which deliverables may be developed as part of competitions and/or may be reviewed as part of the workflow. Deliverables may be developed by a customer, in competition, or in some combination, with portions developed by a customer and portions developed by competition. It should be understood that this workflow is an exemplary framework, and actual projects may include some portion of, or multiple iterations of the deliverables and/or competitions.

A project initiation stage 710 includes defining best practices (e.g., generally, for the competitors and customers to follow) and standards that the customer would like to follow (e.g., company-specific standards), and high-level requirements for the software asset to be developed. In this example, the software asset is a software application.

An concept (also referred to as conceptualization, idea generation or ideating) stage 712 includes a series of competitions for creation of a logo for the application, a storyboard, and a prototype. Competitors in each of these competitions are provided with the project initiation information (which may be “scrubbed” for removal of unnecessary customer-specific and/or confidential information) and the results of the previous competition. Competitors have the opportunity to ask the customer questions about the high level requirements, and through the deliverables help the customer understand what the application will look like. Seeing what the application will actually look, and having a prototype to try, even with limited or prototype functionality, allows the customer to visualize the application, and determine requirements. In some embodiments, these types of competitions may be grouped into the category of “creative” competitions, in which the focus is as much on look and feel, end user interaction, and user interface design and presentation as on the specific functionality.

Also as part of the conceptualization stage 712, a second series of competitions may take place to further develop the customer requirements for the application. These competitions may use the deliverables developed in the earlier competitions. The deliverables may include a market research (also referred to as a business requirements document) is developed, which describes how the application is desired be used as part of the customer's business processes. From the market research document, high-level use cases may be developed. The environment in which the application will run, and performance requirements may be determined. There also may be an opportunity to divide the application into modules. For example, it may be possible to determine that certain sets of uses cases belong in one module, and another set of use cases belong in a second module. To the extent that the requirements may be divided up into separate modules, this will reduce complexity, and also allow for parallel development.

In some cases, some or all of these documents may be generated iteratively. For example, development of the concept documents may result in changes that are needed in the storyboard and/or prototype user interface. Changes may be made to those documents prior to development of the specification 716, for example. Likewise, determinations made in the specification phase may result in changes to the proposed interface, or to the business requirements. Again, these documents may be updated by a customer, deliverable manager, by competition, or otherwise.

Further refinement of the specifications 716 can take place in further competitions to develop a complete application-specific requirements specification, activity diagrams (e.g., non-user-interface activities, since UI activities typically would be part of a storyboard and/or prototype), and a QA test plan. Each of these deliverables may be developed as competitions in the conceptualization category.

From the market research document, use cases, and module definition, system level architecture 714 can be performed, for example through competitions for system level architecture, technical specification, module definition, and component specification. This may be performed in one or a series of architecture competitions for each of these deliverables.

From the system level architecture 714 and the specification stage 716 can follow application level design 720, including an application design specification, component diagram(s), component interface diagram(s), and component specifications (for any components not already available). In some cases, groups of components (e.g., subsystems) may already be available for use.

Also, from the specification stage 716, it is possible to develop test scenarios, scripts, and test documentation through testing competitions. In this way, the requirements are used to developed tests for the overall application. This may also include the construction of test data to be used in testing of components and/or assemblies and/or the assembled application.

Component design/development 718 can follow system level architecture, for example in the case where it is clear that new components, or updates to existing components need to be made to meet system level architecture requirements. Likewise, and more typically perhaps, component design/development 726 can follow application level design, when components specific for the application have been specified in the component specifications. In any case, component design/development may involve one or more competitions to design and/or develop the components, including for example, interface specifications, UML specifications, module specifications, test case generation, and/or coding. An exemplary component development process is described in co-pending U.S. patent application Ser. No. 11/035,783, entitled Systems and Methods for Software Development by Hughes.

System assembly 724 may follow component design/development 724, particularly in the case of a subassembly or framework from existing and/or modified existing components.

In cases where all or a portion of the prototype may be reused, prototype assembly 728 may involve the further development of the prototype based on the specification. It may involve assembly of the prototype with other already existing components. It may involve reworking the prototype to work with the final application.

Application assembly 730 typically is the integration of any assembled subsystems from system assembly 724, components that have been developed 726, and the prototype, which may have been modified in a prototype assembly stage 728. Application assembly 730 can provide assembly code and deployment documentation.

Following assembly 730, the application and the documentation and design deliverables created may be provided to the customer. The application may be certified 732 by the customer and deployed 734. In some cases, members of the community may be engaged, for example, on a contract basis, to help with these stages. Likewise, a deliverable manager may participate in these final stages.

In some embodiments, the competitions described are classified into different categories on the competition management system, for example, conceptualization competitions (e.g., market research, high-level use cases, module definition), creative (also referred to as “Studio”) competitions (e.g., logo design, page design, interface widget design, storyboard, prototype, other graphic design and user interface design/development), architecture competitions (e.g., system level architecture, technical specification, module definition, component specification, application specification design, component diagram, component interface diagram, component specifications), testing competitions (e.g., test scenarios), component competitions (e.g., component design, component development, component modification), and/or assembly competitions (e.g., integration and assembly code, deployment documentation, subassembly integration). These competitions may be offered to development community members by category to make it easier for the community members to identify and participate in the competitions based on their skills and interest. This fosters a software factory model, in which individual community members have development specialties, and can further develop their skills according to their interests. It also facilitates rating, ranking, and rewarding community members for their participation and/or performance in particular categories of development.

Although not shown in the figure, a competition may be held in addition, or as part of the competitions above, for a deliverable manager (also referred to as a “copilot” or project manager) The deliverable manager may be selected based on past performance and/or expertise, or by providing ideas about the process, proposed costs to deliver the application, and so on. A competition may be held for the position of deliverable manager on a particular project. The deliverable manager may be invited to participate based on, for example, qualifications, interests, performance, and so on provided on the competition management system. Deliverable managers may bid on projects that are needed by customers. The competition management system may include a deliverable manager selection system for facilitating selection of an individual member of the community of the developers to serve as a deliverable manager for a project, for example, based at least in part on provided indicia such as performance and so forth. The competition management system may provide indicia of performance of members of the community when serving as a deliverable manager and for updating the indicia for performance of the selected individual member based on the specification and management of the series of competitions.

The deliverable manager may specify the series of competitions that are applicable to the asset to be developed. The deliverable manager may be able to specify timelines and/or provide costs estimates. In some cases, the deliverables and/or costs estimates may be determined in stages. For example, it may not be possible until after an architecture stage to determine what components are needed or need to be modified, and what components are available from a component library or existing functionality. The competition system may facilitate selection of an individual member of the development community to serve as a deliverable manager, for example by providing performance indicia, such as a list of projects in which the deliverable manager participated, and information about the cost/complexity/technical area and so forth, the timing of delivery, percentage of successful competitions, pricing prediction accuracy, successful completion rate, perception/rating by a customer (e.g., as to knowledge, communication, responsiveness, etc.), perception/rating by members of the development community (e.g., as to knowledge, communication, responsiveness, etc.). Biographical/resume data such as training/education/skills also may be provided and may be useful for deliverable managers who have not yet developed a record to judge.

Once selected, the deliverable manager may work with the customer to start the concept development process, for example to run logo, and storyboard competitions, by writing the competition specifications, determining competition prizes, timing, and so forth. The deliverable manager may also assist/oversee selection of winners, and make/coordinate any additional changes desired by the customer. The deliverable manager then may run a prototype competition based on the logo and storyboard, and so on.

In some cases, the competition management system facilitates the interaction of the deliverable manager and the customer by providing a shared workspace that provides the status of competitions that have taken place, are underway, or are scheduled. The workspace also may provide budgeting information, provide access to deliverables, provide a capability to select winners and/or view submissions, provide an ability to schedule reviews to judge competitions, provide tools for communication between the selected deliverable manager and the customer and/or with the community. For example, forum messages/direct communication (e.g., email, instant message, etc.) related to the deliverables may be available or indicated if pending.

In some embodiments, a customer makes a request via a browser in communication with a competition management system for a number of competitions for the development of an asset by specifying prizes and participation criteria for each of the number of competitions, and the customer can monitor progress of each of the number of competitions via the browser in communication with the competition management system. The competition management system may permit granting access to the progress of the number of competitions to an individual other than the individual who requested the number of competitions, and monitoring by the individual other than the individual who requested the competitions the progress of each of the number of competitions via the browser in communication with the competition management system. This may allow, for example, a customer and a deliverable manager from the community to collaborate with each other on the progress of the competitions. This also may allow multiple business entities, or multiple individuals from the same or different business entities to collaborate on the development of one or more assets.

The information about the status of the competitions may be displayed, for example, on a single web page, with further information linked from that page. Each of the competitions may have multiple stages, in which winners of the first stage compete to win a second stage.

Exemplary Dashboard Implementation

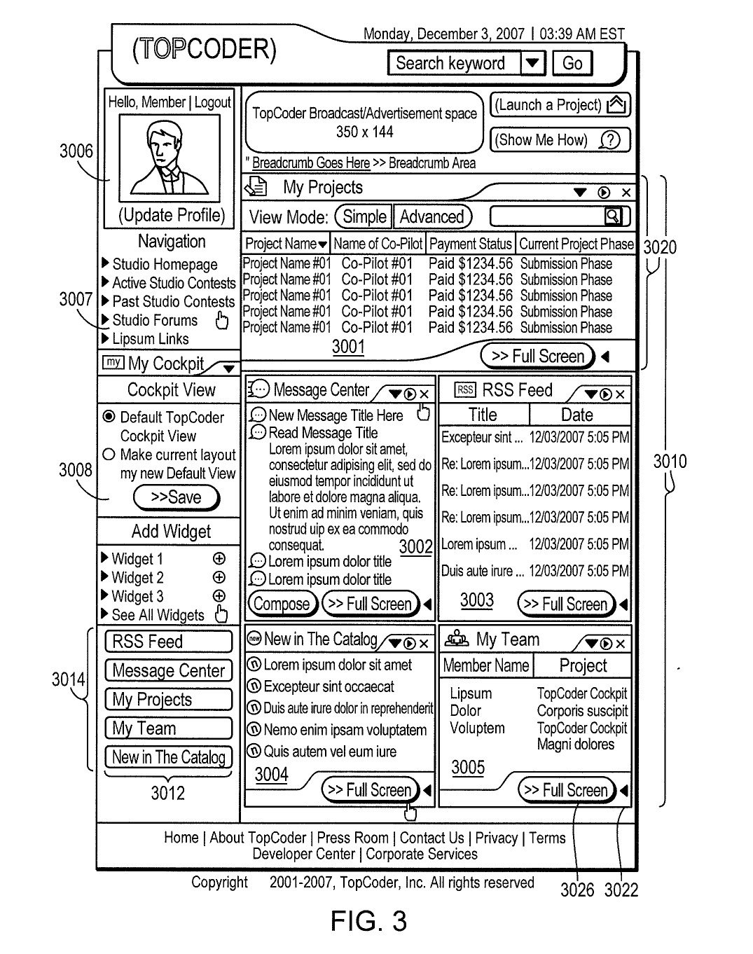

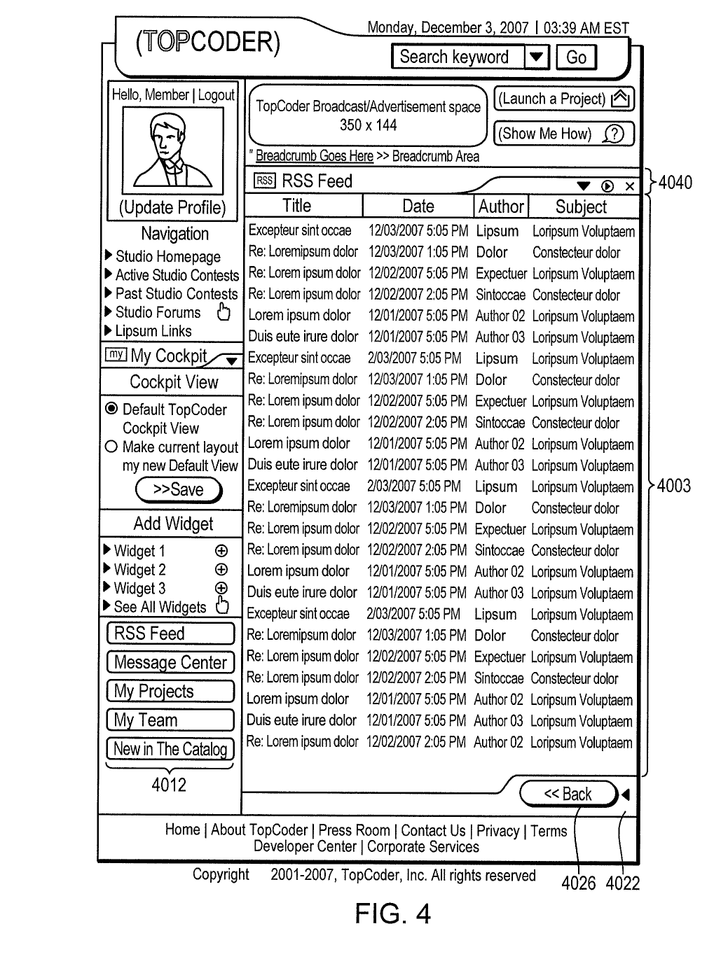

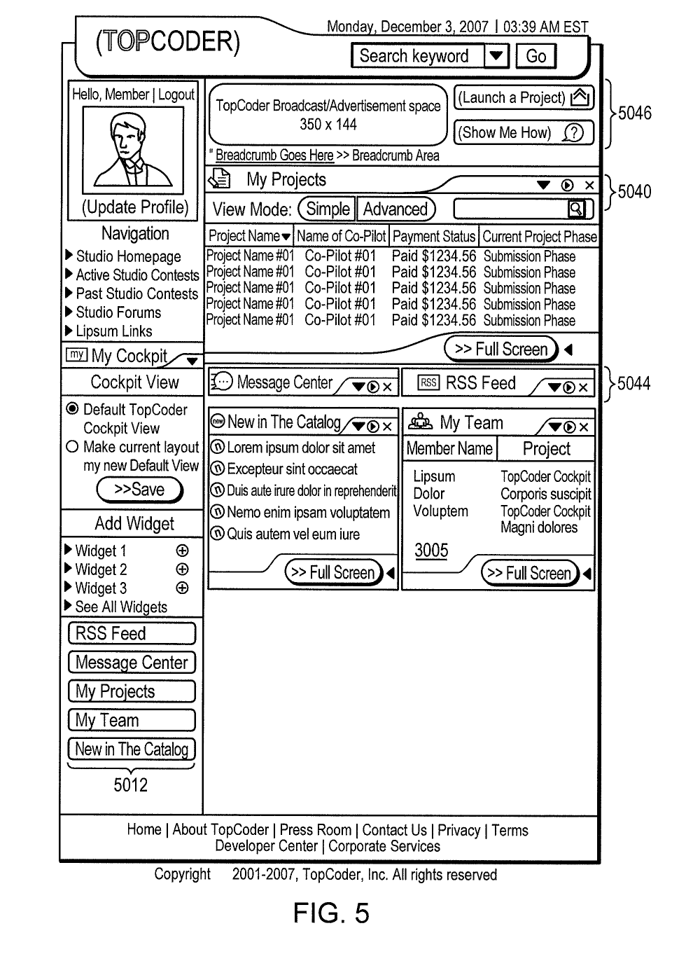

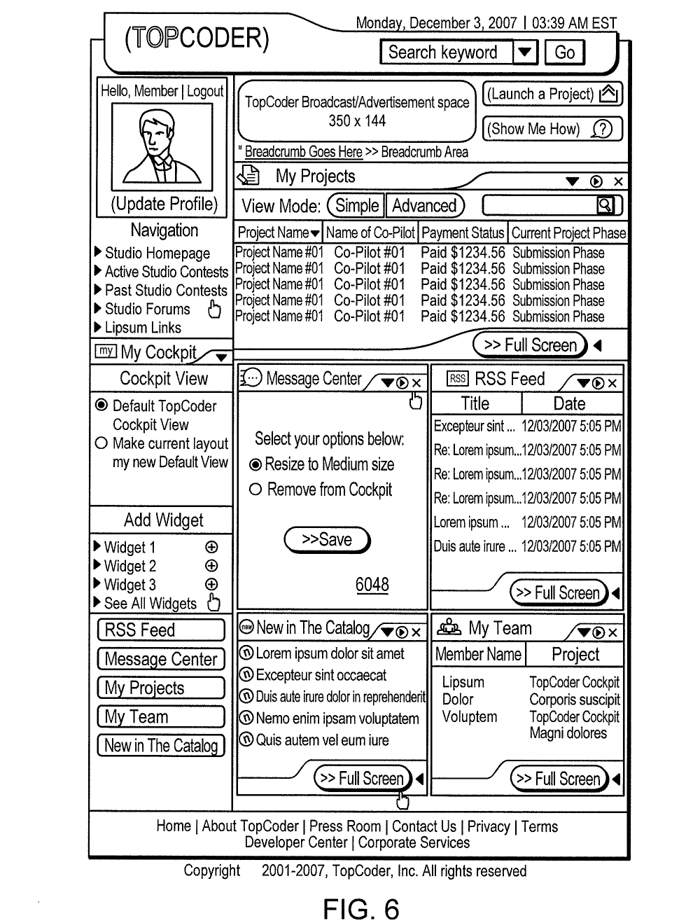

Referring generally to FIG. 3, FIG. 4, FIG. 5, and FIG. 6, in some embodiments, a dashboard application provides an entry point for customers to interact with a community of developers. A customer may be interested in managing the development of work product. Using the dashboard (sometimes referred to in this example as a “cockpit”) customers may launch and track projects, request content to be developed (for example by competition), send/receive messages, and monitor a variety of information sources via a customizable framework of widgets, which can be dragged and dropped into place in any order the customer wishes.

It should be understood that the exemplary screen displays are not limiting, and that they are intended only to illustrate the operation of the exemplary system. For example, FIG. 3 shows one exemplary screen display with a number of widgets 3001-3005 on the display; FIG. 4 shows one of the widgets, the RSS Feed widget (3003 of FIG. 3) expanded; FIG. 5 shows some of the widgets 5044 minimized; FIG. 6 shows one of the widgets 6048 in a configuration mode, in which options are configured.

In this context, the widgets are small functional components operating within a client, for example, a web browser, such that the client can present a number of these small applications as an overall combined application. The client may be another general-purpose or special-purpose application, however, preferably, the client is a web browser such as INTERNET EXPLORER from Microsoft Corporation, or FIREFOX from the Mozilla Foundation. Widgets may be implemented in any suitable technology, depending on purpose, context, and implementation, but in a preferred embodiment are implemented in HTML and Javascript. The widgets may operate as part of a client widget framework that is implemented in JavaScript. The framework utilizes AJAX communication with a data access layer on a server, which data access layer resides within a JBoss Application Server. Widgets may be implemented using the framework, in order to enable the described features.

Referring to FIG. 3, exemplary widgets include a “My Projects” widget 3001, which provides a list of projects that are associated with the individual and information about the projects, a “Message Center” widget 3002 for sending and receiving messages, an “RSS Feed” widget 3003, for providing indications of undated content, a “Now in the Catalog” widget 3004 for providing updates of catalog content, and a “My Team” widget 3005 for providing info about team members. Also on the page is a member profile display 3006 with information about the user, a navigation display 3007 with links to other pages, a “My Cockpit” widget 3008 for configuring the cockpit, and widget buttons 3014 for interacting with the widgets 3001-3005.

Although particularly applicable to the competition systems as described, it should be understood that the widget framework and operation would be suitable for all types of management and interaction tasks, and that the widget framework can also be readily adapted to other types of applications. The framework allows for the arrangement and placement of the functional elements (i.e., the widgets) provided by one or more servers in a manner that can be readily configured by a user based on the user's needs and preferences. The configuration and placement of various widgets enables a flexible interface, which is particularly applicable to, but not exclusive to, dashboard-type monitoring and control activities.

The exemplary dashboard display of FIG. 3 includes a main content area 3010 in which various widgets 3001-3005 are provided. There is no minimum or maximum number of widgets allowable in main content area 3010. The main content area 3010 is treated as divided into rows and columns of a predetermined width and height. A widget in the main content area may be single-wide, which is one column wide and one row high, double-wide, which is two columns wide, one row high, minimized, which is header only, and full screen, such that it fills the entire main content area. Widgets designed for this framework typically provide a different amount or depth of information in the different configurations.

As shown, the main content area 3010 is two widget columns wide, accommodating rows of either two single-wide widgets side-by-side, or one double-wide widget. Widgets in the main content area can be dragged & dropped, moved around on the page, minimized or expanded to double-wide or full screen views. In some embodiments, widgets follow a “snap to grid” behavior pattern, such that no widget covers up another, and widgets move up or down when other widgets are opened, closed, minimized, or eliminated from the page.

A “left nav” space 3012 is a column on the left hand side of the page, to the left of the main content area 3010. The left nav space 3012 may include static html displays as well as more functional widgets.

Red “widget buttons” 3014 are provided as a series of buttons in the left navigation column 3012 corresponding to the widgets the user has elected to include in the dashboard display. For example, a user may choose to close a widget in the main content area 3010, while keeping the corresponding red widget button available in the left nav. These buttons 3014 therefore may operate like a taskbar of widgets, each with specific functionality in different situations, as described further below.

The state, size and position of all widgets for a specific point in time is referred to as the layout. Change to the layout is stored by the server, for example, in an SQL data store via a data persistence layer as the changes occur. This allows the layout to be restored to the most recent state upon closing and restarting of the dashboard page. In some embodiments, data may be stored such that information about the usage and popularity of widgets can be reported.

When a widget in the main content area 3010 is moved, closed, minimized or expanded, the other widgets fill any empty spaces at the top of page, as appropriate. For example, single-wide widgets may move up and down in their respective columns; up to fill a void left by a closed, removed or minimized widget above, and down when pushed by the adding or opening of a widget above. When a single-wide widget is expanded to double-wide, the new double-wide widget maintains its row position, and the adjacent single-wide is be pushed down one position in its column. Widgets below shift downward in the column as needed. Double-wides below may be pushed down as well, in turn pushing widgets in both columns down in the same manner. A double-wide widget moving upward can only move as far empty space exists in both columns. When a widget is dragged into a new position (i.e., moved from one position to another), the adjacent widgets should displace up, down, left or right depending on the position to which the user has dragged and dropped the widget

In some embodiments, a default view is as shown, exemplified by the in the display of FIG. 3, with a double-wide “My Projects” widget 3020 at the top of the main content area.

In some embodiments, a button, such as the small arrow (e.g., 3022) on the bottom right of the widgets is used to control the size of the widgets. Single wide widgets expand to “double-wide” with the click of the small black arrow (such as arrow 3022) at the bottom right of the widget. When the widget is double-wide, the arrow points left. Double wide” widgets revert to “single-wide” when the arrow is clicked. This function may not be available while in full screen mode. In such cases, although the arrow is shown 4022 (FIG. 4) on the widget in full screen mode, this arrow icon need not appear on a widget in full screen mode. A full screen button 3026 may be used to expand a widget to full screen mode.

Referring to FIG. 4, in some embodiments, a widget may include a full screen/back button 4026, located in the figure on the bottom right of the widget. Clicking this expands the widget to full screen mode, as shown in the figure. When one widget enters full screen mode, the other widgets no longer appear in the main content area, and instead are represented by corresponding red widget buttons on the left nav 4012. When a widget is in full screen mode, the full screen button on the widget changes to read “back.” 4026. Clicking “back” may bring the user to his last cockpit view. In other embodiments, clicking back may bring a default view.

Referring to FIG. 5, in some embodiments, widget tools 5040 may be located on the top of each widget. There may be one set of tools 5040, or more than one 4040 (FIG. 4). The location of the tools may be the top, or any suitable location on the widget.

An “X” icon, such as that shown, may remove the widget from the main content area, but will not remove its corresponding red widget button from the left nav 5012. In full screen mode, the “X” performs the same function as the “back” button.

A gears icon opens the configuration tools for the widget. An options menu is provided, for example, by sliding open inside the widget itself. This is shown, for example, in the “Message Center” widget 6048 (FIG. 6). will slide open inside the widget itself. The options that are displayed may vary depending on the functionality of the widget. Exemplary options may include choosing how many items are shown, choosing types of messages to display, removing the widget from the dashboard. Depending on the number of options available, vertical scrollbars may be used. Resizing options may or may not be necessary.

An arrow icon minimizes the widget to a header view only 5044. Widgets below move upward accordingly to rest below the minimized widget header. As mentioned, in some cases, “double-wide” widgets can only move upward as far as equal space in both columns exists, empty space will be left when two columns being uneven. When a widget is minimized, the arrow icon switches to an upward pointing arrow. Clicking this arrow expands widget back to its previous size (or, in some embodiments, to full size), and widgets below shift downward accordingly.

As shown in the figures, buttons are provided at the top of the display 5046 to “Launch a Project”, “Show Me How” and “Update Profile.” These buttons launch full screen widgets in main content area, such as that shown in FIG. 4.

A mini widget in the left nav area 5012 is called “My Cockpit.” It may not be movable from its place, but it may be minimized so that only the top is visible. The red widget buttons move upward/downward under the minimized or maximized “My Cockpit” widget.

There is one red widget button to represent every widget in the main content area to which the user has “subscribed”, whether currently viewable in the main content area or not. For example, if a widget has been closed using the “X” icon, the widget disappears from the main content area, but remains represented by the red widget button in the left nav 5012. In order to fully remove a widget from the dashboard, a user would choose that option in the individual widget configuration. Although, the red widget button is shown as having disappeared when its corresponding widget is taken to full screen view in FIG. 4, the widget button may remain.

In some embodiments, the order of the red widget buttons in the left nav 5012 from top to bottom should follow the order in which the widgets appear in the main content area from top to bottom. In the case of two single-column widgets side-by-side in the main content area, the red widget button representing the left-most widget would take the higher position in the left nav. As an example of this, contrary to the depiction in FIG. 3, the order of the red widget buttons in the left nav during the current layout would be: (1) My Projects; (2) Message Center; (3) RSS Feed; (4) New in the Catalog; (5) My Team.

In the case of a widget that has been closed in the main content area but remains in the left nav, the corresponding red widget button should take a position below the lowest button corresponding to a widget active in the main content area. Text on the red widget button may change to ‘bold’ as appropriate to indicate new information available in corresponding widget. For example, when new mail arrives into the “Message Center” widget, the “Message Center” red widget button in left nav will indicate as such.

Clicking on a Widget Button in Left Nav:

(a) will add that widget to the main content area if that widget is not already shown in the main content area. Added widgets snap to first available (top,left) “single wide” widget position, below “double wide” widget at top of main content area.

(b) will scroll page to the corresponding widget's position in the main content area if it is already on the page

(c) will launch full screen version of the widget (FIG. 4) if full screen is the current view when button is clicked.

(d) will perform the same function as “X” and “Back” if the red widget button clicked corresponds to the widget currently in full screen view.

In some embodiments, a widget button may be dragged into main content area, and a widget in “single wide” view is placed at position of the drop. This function may not be available if the widget already exists in main content area, or if the cockpit is in full screen view. In such case, the widget will simply snap back to left nav.

Exemplary Implementation

In some embodiments, a dashboard application is intended to provide users who want to obtain work product done (referred to as “customers”) with the ability to create and manage projects with minimal or no direct assistance of administrative personnel. Customers use a competition infrastructure and contestants to achieve project goals. In some embodiments, customers create and manage creative competitions (logo, storyboard, user interface design, print and other types of creative competitions), and in other embodiments, create and manage software development, hardware, and other types of development.

In some embodiments, the application provides customers with a customizable central repository to view and manage their own project information. Customers can have their own web pages and the ability to form private groups, as well as other custom functionality. The application enables customers to run competitions quickly and easily, and facilitate a range of competition and project types, including small to medium scope size projects. The application facilitates increased and better member-member as well as member-customer interaction.

In some embodiments, the application exposes data feeds to allow for new components/applications or improve upon existing components/applications.

In some embodiments, the application allows for grouping of payments, so that the customer can pay for a number of competitions or even a number of projects at once. The application may provide monitoring of accounts and payments, and enable payments of prizes. The application also may include a message center, as well as information about contestants, teams, components in a catalog, external data feeds, active competitions, customer ratings, and points.

In one exemplary implementation, a user can login to the customer dashboard application using a username and password. The user also may manually log-out of the application, and may be logged out automatically after a predetermined number of minutes of inactivity.

A number of activities may be performed. As described, these activities may be implemented with a variety of “widgets” but also may be implemented in other ways. Some windows (in the form of widgets) may be provided, for example, to create and manage a customer's projects and competitions. In general, in the event of system or processing failure, an error message is generated to the user. In general, logging is used to track a user's interactions with the system, to prevent fraud and also to help resolve system problems.

A project is associated with a customer, and a number competitions of varying types can be assigned to it. In other words, the hierarchy is: Customer->Project->Competition(s). A customer may have multiple projects and a project may have multiple competitions. Typically, a project may be implemented by running a number of competitions, in series and/or in parallel.

A user who is logged in may create a project. A project is initially created with a status of “draft.” When the customer enters the project name and project description, the project may be created. If the data is not valid, user is prompted to re-enter and create again, and also is provided with a cancel option. The customer receives a confirmation that the project is created.

Generally, in some implementations, the status of a project may be derived from the underlying status of the contests associated with it.

Customers can create one or more competitions or parts of competitions as part of the project creation process. If a customer enters the title of a competition, details are saved even if all details are not yet entered. A user can then retrieve the saved competition details and continue the create competition process to full.

The project is then viewable and editable in a projects window as a draft project. If the project is not successfully added, an error message is displayed.

A customer can manage a project during its life-cycle. Projects management may be done via a projects window, which may be implemented as a widget. A customer who logged in and has at least one active project can manage projects. Changes to the project may be saved as appropriate. The customer may selects an available project from a project list in the projects window. The customer may see a summary view of projects in progress, for example including the name of the project and a summary description of it.

Projects may have a status indicator that depend on the status of competitions associated with that project. For example, if any competition within a project is at red status, the project also may have a status of red. If any competition within a project is at a yellow status, but has no red status competitions, the project status may be yellow. If all of the competitions are in draft state or there are no competitions, then the project status may be grey. If there is at least one active competition, and no competitions with yellow or red status indicators, the project status may be green. If all the competitions are only in abandoned, cancelled or terminated states, then the project status may be black. If the competitions in a project are in completed status, then the project status indicator is grey and an “No Active Contests Message” may be displayed.

Customers may edit the details (e.g., name and description) associated with a project via the projects window interface, with updates saved after confirmation. The system may validate the data and prompt the user to correct any information that is incorrect.

A customer may delete a project if the customer has created that project, and there are no active, in danger, or action-required contests associated with that project. The customer chooses a delete project option and is prompted to confirm. The customer may be required to confirm deletion of project after which the project is deleted. The project history may be stored in a database and available for administrative staff to access.

Competitions

A customer can create a competition if the customer is logged in and has created at least one project. The customer selects an available project from their project list. Customers may be able to create competitions for projects that are in draft or published status. Customers may not be able to create competitions for projects that are completed, cancelled or terminated. A customer may be able to create a competition as part of the new project creation process, or by clicking a “create competition” button for an existing project.

A customer may be presented with available competition choices. The customer may select a competition type. This may trigger the launching of a process specific to the selected competition type to capture the appropriate competition information. The customer agrees to legal terms, which may be customized to the type of competition selected, and the create competition flow terminated if the customer does not agree.

The customer may be prompted to enter competition information. This may include an ability to upload specification documents associated with the competition. If the customer exits prior to completing all of the competition details, the information may be saved. Field may be validated before storing them in the database, with the user prompted to correct any incorrect entries (.e.g., “The information that you entered for X and Y are not valid. Please correct the information on the form,” where X & Y are field(s) that were incorrect.)

The first prize field may be required. An administrator may set a default minimum, depending on contest type, customer type, individual customer, or for the entire system. The customer may be able to upload multiple documents. Customers also may remove an uploaded document. Competitions may have a minimum and maximum submission period that may be configurable based on the type of contest. By default, the minimum length for a competition is 24 hours and the maximum length is 28 days.

The price may be configurable, for example, by fixed amount based on competition type, fixed amount for the entire system, percentage of first prize by competition type, percentage of total prize purse by competition type. The default methodology may be a fixed, system-wide price of $500. If the user attempts to enter a price lower than the minimum or if they enter incorrect decimals or characters, they may be shown an appropriate error message, e.g., “You have entered an incorrect amount in the price field. The amount entered must be at least $500 and in the format: $000.00.”

Competition details may be saved during the create competition process or after entering the competition details. The competition may then be viewable on the project window along with the associated project.

A competition may be have one of the statuses in TABLE 3 that relate to actions required by the customer. In some embodiments, this may be automatically assigned and not editable except by administrative staff.

TABLE 3

| | Status | | Allowable Next | |
|---|---|---|---|---|
| Status Name | Color | Description | Status | Next Status Trigger |
| Draft | Grey | Competition | 1. Published | 1. Customer creates and pays |
| | | details created or | 2. Cancelled | for a competition. |
| | | partially created. | 3. Terminated | 2. Customer cancels the |
| | | No action is | | competition. |
| | | required by | | 3. Administrator terminates |
| | | customer. | | the customer competition. |
| Scheduled | Purple | Competition Paid | 1. Active | 1. Schedule time arrives |
| | | for, not yet | 2. Cancelled | 2. Customer cancels the |
| | | Launched | 3. Terminated | competition. |
| | | | | 3. Administrator terminates the |
| | | | | customer competition |
| Active | Green | Competition paid | 1. Completed | 1. Customer increases prize or |
| | | for and launched. | 2. Cancelled | timeline |
| | | No Action | 3. Terminated | 2. Min Submissions received. |
| | | required by | | 3. Administrator terminates |
| | | customer | | the customer project. |
| Action Required | Yellow | Customer to | 1. In Danger | 1. Customer selects a winner |
| | | choose winner. | 2. Completed | 2. End State |
| In Danger | Red | Within 24 hours of | 1. Completed | |
| | | deadline to choose | 2. Abandoned | |
| | | a Competition | | |
| | | winner | | |
| Insufficient | Yellow | Competition is | 1. Extend | 1. Competition is re-run |
| Submissions/rerun | | complete, | Competition | |
| possible | | insufficient | 2. Abandoned | |
| | | submissions | | |
| | | received. Option | | |
| | | to extend still | | |
| | | possible | | |
| Extended | Green - with | Competition in- | 1. Completed | 1. Customer increases prize or |
| | label of | complete, | 2. Cancelled | timeline |
| | re-run | insufficient | 3. Terminated | 2. Min Submissions received. |
| | | submissions | | 3. Administrator Terminates |
| | | received, contest | | the customer project |
| | | re-run | | |
| Re-Post | Green - with | Competition is | 1. Completed | 1 . Customer increases prize or |
| | label of | complete, | 2. Cancelled | timeline |
| | repost | customer looks at | 3. Terminated | 2. Min Submissions received. |
| | | submissions and | | 3. Administrator Terminates |
| | | doesn't like any, | | the customer project |
| | | re-posts | | |
| | | competition | | |
| Insufficient | Blue | Competition is | 1. Completed | This is a final state. |
| Submissions | | complete, | 2. Cancelled | |
| | | insufficient | 3. Terminated | |
| | | submissions | | |
| | | received. Contest | | |
| | | not-rerun | | |
| No Winner | Blue | Competition is | 1. Completed | This is a final state. |
| Chosen | | complete, | 2. Cancelled | |
| | | customer looks at | 3. Terminated | |
| | | submissions and | | |
| | | doesn't like any | | |
| Completed | Blue | | None | This is a final state |
| Abandoned | Black | No Winner | None | This is a final state. |
| | | chosen, contest | | |
| | | not re-posted or | | |
| | | re-run | | |
| Cancelled | Black | Competition is | | This is a final state. |
| | | cancelled by the | | |
| | | customer. | | |
| Terminated | Black | Competition is | None | This is a final state. |
| | | cancelled by | None | |
| | | Administrator. | | |

Once a competition has been specified, customers may be required to pay for the competition to proceed further. Customers also may save details associated with a competition and return to pay later. Once successful payment has been confirmed, the customer may be notified as to whether the competition is being launched immediately or in the future. The competition may be launched immediately upon the confirmation of successful payment or, after successful payment, launched at the scheduled launch time. In some embodiments, when details about a contest are shown to members, time information (e.g. start of contest) is displayed using that user's local time zone.

A customer may view details of a competition that has been saved. The customer may select a competition by clicking on the competition name in a window. A customer may see publicly available details of a competition in a form field view. A customers may see competition details rendered in the format that a member would see it by clicking on a view competition link.

A customer can edit an active competition as well as one in draft. If a competition is not yet launched, a customer may be able to edit the details, but if a competition is in progress then the edits may be limited to increasing timeline and prize fields.

A competition may be chosen for editing from an edit details link associated with each competition. A customer may choose to edit details of a saved competition prior to launch. In some implementations, after a competition is paid for and launched, the customer may increase the prize money or extend the contest timeline. Contests prizes and timelines may be updated multiple times in the course of the submission phase (i.e. contest has not ended), although the total timeline for a competition may only be extended to the maximum value allowed for that contest type. Fields may be validated for accuracy after the user has completed entry. Competition details may be saved and updated.

Updated competition details may be viewable via the projects window via a “view details” screen. Clicking on view details may bring up the competition details as well as the ability to continue on to “launch a competition”.

A customer can choose to pay for a competition as part of the create competition process, for example, at the time of creating a competition. A customer may go back to a previously saved competition and pay for it. Once a customer has created a competition and provided the necessary contest details, the customer can pay for the competition, and the competition then may be launched or scheduled to be launched at a date and time specified by the customer.

A competition may be chosen for launch via a project window interface. Customers can click on a “view competition details” icon and then resume launching of a competition. Once successful payment has been confirmed, the customer will be notified as to when the competition will be launched (e.g., immediately or in the future, as appropriate).

In some implementations, there are various cases, some of which are listed in TABLE 4, in which a payment function may be invoked. In general, in some implementations, customers pay a cost for using the competition infrastructure prior to launching a contest (Payment type Launch). Some fees may be waived for business reasons (Payment type=No Fee). If a customer is extending a contest, then the Payment Type=Extend. Customers also pay an additional amount when a contest is over to be able to download winning submissions (payment type=Download) and if the customer wishes to purchase additional submissions in the future (Payment Type=Additional). There may be a premium in some circumstances, for example when a customer abandons a contest, but then chooses to purchase submissions in the future. Payment Type=Additional_Premium Another payment is for re-posting a competition. Other payments also may be collected instead or in addition.

TABLE 4

| Value | Description | Fee Description |
|---|---|---|
| Launch | Fee that is paid prior to launching a | A fixed amount OR a |
| | contest for use of the TopCoder | percentage of the 1^{st} prize OR |
| | Infrastructure | a percentage of the total |
| | | prizes - all configurable on a |
| | | system and contest basis |
| No_Fee | Fee is waived for business reason | Customer allowed to extend |
| | | for free (once) if min no of |
| | | submissions not received. |
| | | Admin price fee = $0 |
| Extend | Competition is being extended | May be same as launch or a |
| | | portion of launch fee (or 0). |
| Download | Prize money that is paid by customer to | Prize amount specified in |
| | download the winning submission(s) | contest details |
| Additional | Customer wishes to purchase additional | Cost of first place prize |
| | submissions, having chosen a winner for | |
| | the competition within the required time | |
| | period | |
| Additional_Premium | Customer abandons contest, and wishes | Y × 1^{st} place prize where Y is |
| | to purchase | configurable on contest and |
| | | system basis with a default of |
| | | 1.5 |
| Re-Post | Customer chooses to re-post the | X% × Original |
| | competition after rejecting all of the | Administration fee. By |
| | submissions. | default X is 75% but |
| | | configurable on a contest and |
| | | system basis. |

With respect to payment, logging may be a higher level than normal and may trigger an email or other notification to a system administrator.

For processing payment, the amount that the customer is required to pay is presented. Payment amount may be determined by the particular functionality that the customer has invoked, and may be a fee set by the administrator, a prize amount specified by the customer when setting up the competition, or both. Customers use one of the supported payment methods (e.g., credit cards, on-line payment service, etc.).

A customer may be notified whether payment for the competition was successful and be provided with a confirmation record. A customer may be notified if payment was unsuccessful and will be re-directed to alternate recourse to achieve successful payment.

Administrators may be notified when a payment by a customer has been made. Tracking of transactions may be useful for bookkeeping purposes. If an action is unsuccessful, an appropriate message may be sent to an administrator with such information as the customer name, payment type, payment amount and contact details for customer.

Once a customer has created a competition and pays for the competition, the customer may launch the competition. When launching a competition, a customer can choose to launch it immediately or schedule a date/time to be automatically launched. The customer may in this way schedule multiple competitions to launch at the same time (current or future).

When a competition is launched, a forum for the competition may be created and added to the user's forum list. The competition may be visible to the community once the competition is active.

The customer may be notified as to whether the competition is being launched immediately or in the future. If a competition is scheduled to launch at or prior to the time at which a successful payment for that competition was made, then that competition will launch immediately upon payment. If a competition was scheduled to launch in the future, then the competition will automatically be launched at that date/time.

Contest documents uploaded during the create contest details process are automatically posted in a document thread in the competition forum.

Any forums associated with a competition may be added to the customer's forums window. The forums window may be updated manually by designating the forum.

A competition may be visible to the community via an active competitions link either immediately or at the point at which the competition is scheduled to be launched.

When a competition has been launched, and is paid for and active, customers may manage a competition in progress, including monitoring forums, updating timelines, updating prizes, viewing registrants, and receiving and viewing submissions. The user can view competition information.

Competitions in progress may be viewed via the project window interface. Status indicators may be color-coded to provide a quick summary view of all competitions on a per-project basis.

Customers monitor competition forums. Customers may post updated specifications, answer questions or provide further guidance to competitors via the forum.

Customers can view submissions that are available while the competition is in progress. Customers may see a summary page showing the number of registrants; the number of submissions as well as other competition information. Customers may drill down into the submissions to view individual submissions. Customers may not be able to see individual distinguishing information, including user names, about a particular submitter.

In some implementations, submissions are watermarked, such that visible artifacts are added to the image. In this way customers can view the images, but they are not useful end product. In the event of system or processing failure, the following error message is generated to the user:

The user may choose to increase the timelines or prize within a competition while it is in progress. Updated details are saved and displayed back to the user. In some implementations, if a customer attempts to decrease the prize or the timeline amount for this competition, a message is displayed stating that timelines and prize amounts may only be increased from their original posted values.

At the end of some types of contests, for example if the competition submission phase is complete, customers may be able to select a winner. A customer may chose a winner, abandon a contest, or re-run the competition if appropriate. In other competitions, the competition includes a review phase, and other phases, in which community members select a winner. In some cases both community members and one or more customers participate in winner selection.

Generally, for creative-type contests, the customer selects the winner. There may be screening or other processes in which administrators or community members help review or screen submissions or portions of submissions. For example, there may be a review to determine whether the images appear to be of sufficient quality, meet the formal requirements, and appear to be original. In other competitions, such reviews are not included in the process.

Customers may be notified by email at the end of a contest. If a competition has received less than the required minimum of submissions, the customer may be given the option to extend the competition if the competition has not previously been extended (e.g., if extension is only possible once). If the minimum number of submissions has been received, a “pick a winner” period begins, and the customer may perform an action or re-post the competition (for example, paying a second administrative fee to do so.)

Customers may be sent reminder notices at various times if they have not already chosen a winner when there are a number of hours remaining, which may be configurable, for example, 24 hours remaining until the end of a “choose a winner” period, 8 hours remaining and 1 hour remaining. Customers may be provided a link to the application and contest in the messages sent to them.

Customers can choose to view the submissions in progress for a particular competition by clicking on a view submissions link. The submissions may be presented in a thumbnail, compressed format (e.g., jpeg). When displayed, the submissions may be watermarked, such that there are deliberate visible artifacts in the image. When customers move their mouse over a particular submission thumbnail, they may see an enlarged version of that thumbnail.

In some implementations, customers rank a number of choices (e.g., their first 5 choices) amongst the submissions. This ranking may be used for differentiating or rewarding submissions that were close to being the winner but did not win. Ranking may be configured to allow multiple places, or to allow multiple submissions to share a ranking.

Customers may not be allowed to confirm a winner until they have first completed the ranking action. Attempts to do so may generate the following message to the user: “You have improperly ranked the submissions from 1 to 5. Please correct your rank accordingly.”

Customers also may choose a winner. Customers may specify one or more winners. For example, customers may specify multiple prizes when creating a contest, for example, the customer may specify that there may be more than one first place chosen, depending on the submissions, or that there will be first place, second place, etc. Having multiple places may increase the number of contestants.

Customers may choose to “abandon” a contest if they do not pick a winner within the required time.

The customer confirms a choice to purchase and download. Winning Submissions as well as other submissions marked for purchase may be paid-for prior to being available for download.

The customer may be presented with an interface allowing them to download purchased submissions. In some implementations, the customer has the option to purchase additional, non-winning submissions in accordance with the business and payment rules. For example, unpurchased submissions may be purchased within a 90 day period.

Winners may be notified via email of their win. Payments of prizes to winning contestants may be made by the administrator.

If a competition ends with less than a minimum number of submissions, a customer may choose to extend the competition. The minimum number of submissions may be based on the contest type, and may be configurable.

For example, each contest may have a minimum number of submissions associated with it (default=10). Minimum submission numbers will be configurable on a per contest-type or system-wide basis. If there are less than the required number of minimum submissions, the customer has the option to extend the contest. In some cases, only competitions that have not previously been extended, and that have not received the minimum number of submissions can be extended. In such cases, if a competition has already been extended once before or if the minimum number of submissions has been received, then the customer is provided with an option to “re-post” the competition. Customers may be notified via email and in the view submissions screen about the ability to extend a competition where applicable.

Clicking on an “extend competition” button (e.g., that is only available on a view submissions page for eligible competitions) allows the customer to increase the timeline and/or the prize(s) associated with that competition. Other changes (e.g., specification updates, etc.) may be done on the forums.

If a customer attempts to enter a timeline that is longer than the maximum allowed for that contest, the customer is so notified, for example with the following message: “You have attempted to extend the length of the competition for longer than is allowed. Please adjust the end date of the competition accordingly”.

A competition may be re-launched on a new schedule and updated contest details, for example, if it is not eligible for an extension and there are not enough submissions, or if the customer does not like any of the submissions.

In some implementations, if a competition has received the minimum number of submissions for that contest type, then the customer does NOT have the option to extend that competition, but if the customer does not like any of the submissions, the customer can choose to re-post the competition. Customers may be notified via email and/or in a view submissions display of the ability to re-post a competition.

Clicking on a “re-post competition” button, for example that is available on a view submissions display if the extend competition option is not available, may bring up a contest details screen that can be edited, and which allows the customer to change details associated with that competition.

Customers again go through the payment and competition launch steps, in some cases including payment of an administrative fee, which may be a percentage of the prize money to be offered, or otherwise.

A competition may be re-posted with the new schedule and other updated contest details. The forum originally created for the competition may be re-used when the competition is re-launched to preserve historical information for customers and members.

In some implementations, and for some competitions, a customer may purchase non-winning submissions for up to a number a days (e.g., 60 days, 90 days) after a contest has ended. This purchase period may be configurable by contest type. Customers can choose to view the thumbnail or compressed versions of submissions during the purchase period. Submissions may be kept on file for a configurable period of time so that they may be available for download to the customer.

The customer may be presented with a screen showing submissions for the contest. Submissions that have already been purchased may be re-downloaded while submissions not yet purchased may have a “purchase” option attached to them. Customers may purchase a submission for the same price as the first prize in the competition.

In some implementations, if a customer abandons a contest, and they later choose to purchase a submission for this contest, they may be charged a premium, for example 1.5 time the prize value.

Winning Submissions may be required to be paid for prior to being available for download to the customer.

Contestants whose submissions have been purchased may be notified via email. Payments of prizes to winning members may be the responsibility of the administrator. Members may be paid when their work is chosen by a customer as a winning submission or when a customer has chosen to purchase their work.

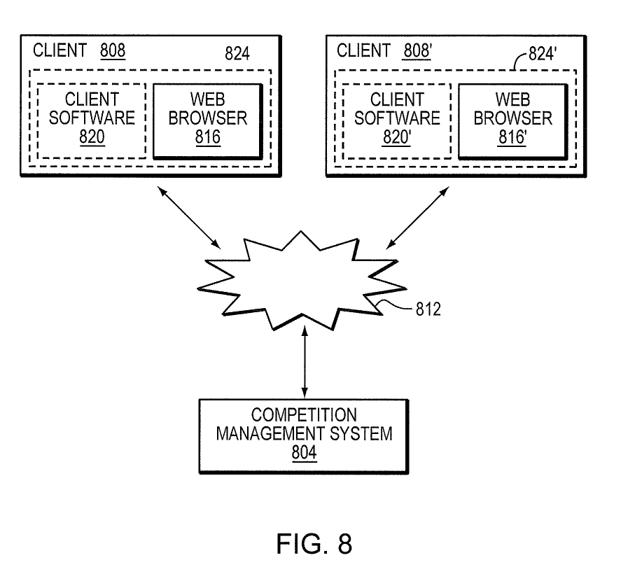

Referring to FIG. 8, in one embodiment, a competition management system 801 includes at least one server 804, and at least one client 808, 808′, generally 808. As shown, the distributed software development system includes two clients 808, 808′, but this is only for exemplary purposes, and it is intended that there can be any number of clients 108. The client 108 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the OS X MACINTOSH operating system from Apple Computer of Cupertino, Calif., and various varieties of Unix, such as SUN SOLARIS from SUN MICROSYSTEMS, and GNU/Linux, for example, from RED HAT, INC. of Durham, N.C. (and others). The client 808 could also be implemented on such hardware as a smart or dumb terminal, network computer, wireless device, handheld device, wireless telephone, information appliance, workstation, minicomputer, mainframe computer, or other computing device, that is operated as a general purpose computer, or a special purpose hardware device used solely for serving as a client 808 to the competition management system.

Generally, in some embodiments, clients 808 can be operated and used by software developers to participate in various software development activities. Examples of software development activities include, but are not limited to software development projects, software design projects, testing software programs, creating and/or editing documentation, participating in programming contests, building applications, as well as others. Clients 808 can also be operated by entities who have requested that the software developers develop software (e.g., customers). The customers may use the clients 808 to review software developed by the software developers, post specifications for the development of software programs, test software modules, view information about the developers, as well as other activities described herein. The clients 808 may also be operated by a facilitator, acting as an intermediary between the customers and the software developers.

In various embodiments, the client computer 808 includes a web browser 816, client software 820, or both. The web browser 816 allows the client 808 to request a web page or other downloadable program, applet, or document (e.g., from the server 804) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client 808 manually requests a web page from the server 804. Alternatively, the client 808 automatically makes requests with the web browser 816. Examples of commercially available web browser software 816 are INTERNET EXPLORER, offered by Microsoft Corporation, Safari offered by APPLE, or FIREFOX offered by the Mozilla Foundation.

In some embodiments, the client 808 also includes client software 820. The client software 820 provides functionality to the client 808 that allows an individual to participate, supervise, facilitate, or observe development activities described above. The software 820 may be implemented in various forms, for example, it may be in the form of a Java applet that is downloaded to the client 808 and runs in conjunction with the web browser 816, or the client software 820 may be in the form of a standalone application, implemented in a multi-platform language such as Java or in native processor executable code. The software 820 may be in the form of widgets, as described above. In one embodiment, if executing on the client 808, the client software 820 opens a network connection to the server 804 over the communications network 812 and communicates via that connection to the server 804. The client software 820 and the web browser 816 may be part of a single client-server interface 824; for example, the client software can be implemented as a “plug-in” to the web browser 816.

A communications network 812 connects the client 808 with the server 804. The communication may take place via any media or any combination of media such as standard telephone lines, LAN or WAN links (e.g., T1, T3, 56 kb, X.25), broadband connections (ISDN, Frame Relay, ATM), wireless links (802.11, bluetooth, etc.), and so on. Preferably, the network 812 can carry TCP/IP protocol communications, and HTTP/HTTPS requests made by the web browser 816 and the connection between the client software 820 and the server 804 can be communicated over such TCP/IP networks. The type of network is not a limitation, however, and any suitable network may be used. Non-limiting examples of networks that can serve as or be part of the communications network 812 include a wireless or wired ethernet-based intranet, a local or wide-area network (LAN or WAN), and/or the global communications network known as the Internet, which may accommodate many different communications media and protocols.

The competition management system servers 804 interact with clients 808. The server 804 is preferably implemented on one or more server class computers that have sufficient memory, data storage, and processing power and that run a server class operating system (e.g., SUN Solaris, GNU/Linux, and the MICROSOFT WINDOWS family of operating systems). The servers may be available on a cloud computing system. Other types of system hardware and software than that described herein may also be used, depending on the capacity of the device and the number of users and the size of the user base. For example, the server 804 may be or may be part of a logical group of one or more servers such as a server farm or server network. As another example, there could be multiple servers 804 that may be associated or connected with each other, or multiple servers could operate independently, but with shared data. In a further embodiment and as is typical in large-scale systems, application software could be implemented in components, with different components running on different server computers, on the same server, or some combination.

In one embodiment, the server 804 and clients 808 enable the distributed software and graphics design development and/or assembly by one or more individuals, which individuals may or may not be associated with a particular entity requesting the development of the software program. A software program can be any sort of instructions for a machine, including, for example, without limitation, a component, a class, a library, an application, an applet, a script, a logic table, a data block, a widget, a user interface element, or any combination or collection of one or more of any one or more of these.

In one embodiment, the software program is a software component. Generally, a software component is a functional software module that may be a reusable building block of an application. A component can have any function or functionality. Just as a few examples, software components may include, but are not limited to, such components as graphical user interface tools, a small interest calculator, an interface to a database manager, calculations for actuarial tables, a DNA search function, an interface to a manufacturing numerical control machine for the purpose of machining manufactured parts, a public/private key encryption algorithm, and functions for login and communication with a host application (e.g., insurance adjustment and point of sale (POS) product tracking). In some embodiments, components communicate with each other for needed services (e.g., over the communications network 812). A specific example of a component is a JavaBean, which is a component written in the Java programming language. A component can also be written in any other language, including without limitation Visual Basic, C++, Java, and C#.

In one embodiment, the software program is an application. The application may be comprised of one or more software components. In one embodiment, the software application is comprised of software components previously developed using the methods described herein. In some embodiments, the application comprises entirely new software programs. In some embodiments, the application comprises a combination of new software programs and previously developed software programs.

The competition management system allows for the holding of competitions among a diverse group of competitors, and the interaction of customers, competitors, and deliverable managers, among others, as described herein.

General Applicability

Although described here with reference to software, and useful when implemented with regard to software assets, the cooperatively developed product can be any sort of tangible or intangible object that embodies intellectual property. As non-limiting examples, the techniques could be used for computer hardware and electronics designs, or other designs such as architecture, construction, or landscape design. Other non-limiting examples for which the techniques could be used include the development of all kinds of written documents and content such as documentation and articles for papers or periodicals (whether on-line or on paper), research papers, scripts, multimedia content, legal documents, and more.

What is claimed is:

1. A method for creating a deliverable comprising holding a series of on-line competitions using a competition management system, each of the competitions for the development of one or more assets, a number of which assets together comprise the deliverable, wherein each of the competitions to be held are selected based on the desired characteristics of the deliverable.

2. The method of claim 1 wherein the competitions are selected from choices of competition types offered by the competition management system.

3. The method of claim 1 wherein the competitions to be held are selected automatically based on the desired deliverable.

4. The method of claim 1 wherein the competitions to be held are selected by an administrator.

5. The method of claim 1 wherein some of the competitions are selected from a list of competitions to be held produced as part of an asset developed through one of the competitions.

6. The method of claim 4 wherein a first series of competitions for development of assets are specified and held, after which a second series of competitions are held based on the list of competitions specified as an asset developed through one of the competitions.

7. The method of claim 1 wherein holding a competition comprises specifying start date/time, end date/time, prize, and specification of the asset to be developed.

8. The method of claim 1, wherein the customer for the deliverable accesses the competition management system directly to request and initiate the series of competitions.

9. The method of claim 1, wherein one or more of the assets are software designs.

10. The method of claim 1, wherein one or more of the assets are requirements descriptions.

11. A method for developing software, comprising holding a series of on-line competitions using a competition management system, wherein individuals compete against each other to develop and submit assets, which are then judged and a winner selected, the method comprising:
holding a competition for the development of an application specification in which a winning application specification is selected;
holding an architecture competition for the development of application architecture based on the winning application specification in which a winning application architecture is selected, wherein the winning application architecture comprises specification of components;
holding one or more component design competitions for a respective one or more of the specified application components in which a winning component design is selected in each component design competition, each respective winning design comprising component design documentation;
holding component development competitions for development of components based on the winning designs, the components comprising an implementation of the winning design; and
holding an assembly competition for assembly of the components specified in the winning application architecture in which a winning assembled application is selected.

12. The method of claim 11, further comprising holding a testing competition for development of tests for testing of the winning application.

13. The method of claim 11, further comprising holding a competition for the development of a wireframe in which a winning wireframe is selected.

14. The method of claim 11, further comprising holding a competition for the development of user interface design.

15. The method of claim 11, further comprising holding a competition for the development of a static prototype based on a storyboard developed by competition, a wireframe developed by competition, or both, and the winning application specification.

16. The method of claim 11, further comprising holding a competition for the translation of the application interface into another human language.

17. A competition management system for holding a series of on-line competitions for developing software, such that individuals compete against each other to develop and submit assets, which are then judged and a winner selected, the system comprising:
an application specification competition subsystem for holding a competition for the development of an application specification in which a winning application specification is selected;
an architecture competition subsystem for holding an architecture competition for the development of application architecture based on the winning application specification in which a winning application architecture is selected, wherein the winning application architecture comprises specification of components;
a component design subsystem for holding one or more component design competitions for a respective one or more of the specified application components in which a winning component design is selected in each component design competition, each respective winning design comprising component design documentation;
a component development subsystem for holding component development competitions for development of components based on the winning designs, the components comprising an implementation of the winning design; and
an assembly competition subsystem for holding an assembly competition for assembly of the components specified in the winning application architecture in which a winning assembled application is selected.

18. The system of claim 17, further comprising a creative design subsystem for holding a competition for the development of graphic design elements of the software application.

19. The system of claim 18, further comprising a user interface design subsystem for holding a competition for the development of user interface design.

20. The system of claim 17, further comprising a translation competition subsystem for holding a competition for the translation of text into another human language.

21. A method for developing software, comprising holding a series of on-line competitions using a competition management system, the method comprising:
holding a competition for the development of a wireframe;
holding a competition for the development of a storyboard based on the winning wireframe;
holding a competition for the development of a static prototype based on the winning storyboard.

22. The method of claim 21 wherein the storyboard comprises a visual design for the software user interface.

23. The method of claim 21, wherein the static prototype comprises a HTML prototype.

24. The method of claim 21, further comprising holding a competition for the development of a working prototype.

25. The method of claim 21, further comprising holding a competition for the development of an application based on the working prototype.

26. The method of claim 21, further comprising holding a competition for the development user interface elements based on the static prototype and an application programming interface specification.

27. The method of claim 21, further comprising holding a competition for the translation of the working prototype into another language.

28. The method of claim 21, wherein the winner of the competition to develop the storyboard is selected by the customer.

29. A method for developing software, comprising:
developing a wireframe;
holding a competition for the development of a static prototype based on the wireframe;
holding a competition for the development of a working prototype based on the static prototype.

30. The method of claim 29 further comprising holding a competition for the development of an application specification based on the working prototype in which a winning application specification based on the working prototype is selected.

31. A method of creating a specification specifying the requirements for an asset, comprising:
providing an electronic form on a competition management system for completion by a customer, the form specifying information about a desired asset;
providing the completed form on the competition management system to competitors in a competition to define the requirements for the asset;
providing on the competition management system a communications forum shared among competitors and the customer for discussing the information in the electronic form and the customer's desired requirements;
conducting via the competition management system a competition for the development of a requirements specification for the asset based on the electronic form and the communications forum, in which competitors each submit a requirements specification and the customer selects the winning specification.

32. A method of creating a specification specifying the requirements for an asset, comprising:
receiving by a competition management system a request by a customer to conduct a competition for the development of an asset;
providing by the competition management system an electronic form for completion by the customer, the form specifying information about a desired asset;
designating a competition type based on the information provided by the customer in the completed electronic form;
designating competition rules based on the competition type;
conducting via the competition management system a competition for the development of the asset based on the information in the electronic form, in which competitors each submit an asset and the customer selects the winning asset from among the submitted asset.

33. The method of claim 32, further comprising providing by the competition management system a communications forum shared among the competitors and the customer for discussing the information in the electronic form and the customer's desired requirements for the asset.

34. A method for conducting competitions, comprising:
requesting via a browser in communication with a competition management system a number of competitions for the development of an asset by specifying prizes and participation criteria for each of the number of competitions; and
monitoring progress of each of the number of competitions via the browser in communication with the competition management system.

35. The method of claim 34, further comprising, granting access to the progress of the number of competitions to an individual other than the individual who requested the number of competitions, and monitoring by the individual other than the individual who requested the competitions the progress of each of the number of competitions via the browser in communication with the competition management system.

36. The method of claim 35, wherein the access is granted to a customer.

37. The method of claim 35, wherein the access is granted to an individual member of the community serving as a deliverable manager.

38. The method of claim 35, wherein the progress of the number of competitions is displayed on a single web page.

39. The method of claim 35, wherein at least one of the number of competitions comprises multiple stages, in which winners of the first stage compete to win a second stage.

40. A method for creating a deliverable through the efforts of a community of developers using a competition management system, comprising:
providing indicia for performance of members of the community when serving as a deliverable manager;
facilitating selection of an individual member of the community of the developers to serve as the deliverable manager based at least in part on the provided indicia;
facilitating specification and management of a series of competitions by the selected individual member using the competition management system; and
updating the indicia for performance of the selected individual member based on the specification and management of the series of competitions.

41. The method of claim 40, wherein the performance of the deliverable manager is determined at least in part by the successful completion of the deliverable.

42. The method of claim 40, wherein the performance of the deliverable manager may be determined at least in part by the timing of delivery.

43. The method of claim 40, wherein the performance of the deliverable manager may be determined at least in part by the rating of the deliverable manager by a customer using the competition management system according to a scorecard.

44. The method of claim 43, wherein the scorecard comprises determination of the accuracy of the pricing predictions of the deliverable manager.

45. The method of claim 43, wherein the scorecard comprises determination of the accuracy of the timing predictions of the deliverable manager.

46. A competition management system for creating a deliverable through the efforts of a community of developers, comprising:
a deliverable manager selection system for facilitating selection of an individual member of the community of the developers to serve as a deliverable manager for a project based at least in part on provided indicia;
a competition specification system for facilitating specification and management of a series of competitions by the selected individual member using the competition management system; and
a deliverable manager rating system for providing indicia of performance of members of the community when serving as a deliverable manager and for updating the indicia for performance of the selected individual member based on the specification and management of the series of competitions.

47. The competition management system of claim 46 wherein the competition management system comprises tools for communication between the selected deliverable manager and the customer associated with a project.

48. The competition management system of claim 47 wherein the customer and the deliverable manager can both access a page providing the status of competitions for the project.
